(19) United States
(12) Patent Application Publication
(10) Pub. No.: US 2015/0301721 A1
(43) Pub. Date: Oct. 22, 2015

(54) DESKTOP PUBLISHING TOOL

(71) Applicant: n2y LLC, Huron, OH (US)

(72) Inventor: Jacquelyn A. Clark, Huron, OH (US)

(21) Appl. No.: 14/587,405

(22) Filed: Dec. 31, 2014

Related U.S. Application Data
(60) Provisional application No. 61/923,011, filed on Jan. 2, 2014.

(51) Int. Cl. G06F 3/0484; H04L 29/08; G06F 17/21; G06F 17/22

(52) U.S. Cl. CPC G06F 3/04842; G06F 17/2217; H04L 67/02; G06F 17/214

(57) ABSTRACT

An Integrated desktop publishing platform supporting document layout, typography, symbolate-text-as-you-type, spellcheck, table of contents creation, text-to-speech configuration, code-free interactivity programming, support for collaboration between content authors, and cloud publishing the web accessible content using a single tool.

### CROSS-REFERENCES TO RELATED APPLICATIONS

This application claims the benefit of provisional application Ser. No. 61/923,011, filed on Jan. 2, 2014, and incorporated herein by reference.

### BACKGROUND

There is currently no unified platform for creating, publishing and delivering spoken, interactive, symbolated content to consumers via a modern web browser and without requiring the use of browser plugins, stand-alone desktop software, or custom programming for each interactive document.

A web-based platform that provides the familiar tools of “desktop publishing” for traditional print documents where both the content creation tools as well as the published content are web based and delivered via the cloud is desirable. Content consumers need nothing other than a modern web browser to view and interact with such published content.

### SUMMARY

Provided is an Integrated desktop publishing platform supporting document layout, typography, symbolate-text-as-you-type, spellcheck, table of contents creation, text-to-speech configuration, code-free interactivity programming, support for collaboration between content authors and publishing to the web accessible content using a single tool. The conventional approach would require using multiple different tools from different vendors in a manual workflow that is fragile and error prone.

The system provides a WYSIWYG (what you see is what you get) content creation: content creation is performed in such as a way as to ensure that what a content author designs is what content consumers will experience.

The example embodiments include a solution that supports Web-based & plugin-free document creation and viewing: traditionally the degree of interactivity, sound, rich media, typography and pixel precise layouts offered by iDocs would require plugins (such as Adobe Reader or Flash). This can be a problem because plugins can pose security risks (because hackers tend to exploit them first), because such plugins are not supported on most mobile phone and tablet devices, and because plugins consume the battery life of mobile devices more quickly than using the browser alone. In the example embodiments, all components in the Editor and Viewer are HTML 5 based, require only a modern web browser, and are accessible from a wide range of desktop, mobile and tablet devices without requiring a plugin.

The example embodiments are designed to run in the cloud: the platform storing and delivering the content was architected for the cloud from the ground up to provide a highly scalable solution that does not require end users to install any software.

Provided are a plurality of example embodiments, including, but not limited to, a method of creating a symbolated document using a server comprising one or more computers and databases for executing specialized software for implementing said method which comprises the steps of:
the server sending instructions over a computer network to a remote computing device to cause the remote computing device to provide a user interface process including the steps of:
accepting textual words from a user for display in the document,
automatically suggesting a plurality of symbols, each comprising a graphical picture, for each one of at least a subset of said words, one at a time,
for each one of said subset of words, accepting a selection of one of said suggested one or more symbols for associating with that respective one of the words,
displaying the symbolated document on the remote computer device showing the textual words with the associated symbols, and
sending document data representing the symbolated document displayed on the remote computing device to the server;
the server storing the document data; and
the server using the stored document data for interacting with one or more additional remote computing devices over the computer network for displaying the symbolated document on the additional remote computing devices.

Further provided is the above method, wherein said user interface includes a step of automatically converting the textual words to speech, and wherein the displaying of the symbolated document on the additional remote computing devices includes providing the capability to convert the textual words to speech.

Further provided are any of the above methods, wherein said user interface includes accepting a user input for setting a speed of the speech.

Further provided are any of the above methods, wherein said user interface includes providing a user with one or more interactive puzzles for adding to the symbolated document.

Further provided are any of the above methods, wherein said user interface includes a global replace function for automatically replacing a plurality of a symbol that is associated with multiple instances of a particular word with another symbol for associating with that particular word.

Further provided are any of the above methods, wherein each one of said symbols is displayed near its respective associated word in the symbolated document.

Further provided are any of the above methods, wherein each one of said symbols is displayed under or over its respective associated word in the symbolated document.

Further provided are any of the above methods, wherein said user interface utilizes a standard web browser executing on the remote computing device.

Further provided are any of the above methods, wherein said user interface is executed without the use of a plug in for said web browser.

Further provided are any of the above methods, wherein said user interface includes a spell check function that automatically suggests corrections to misspelled words.

Further provided are any of the above methods, wherein said user interface includes a function to automatically generate a table of contents for the symbolated document.

Further provided are any of the above methods, wherein said user interface includes a graphical editor for graphically editing any of the symbols.

Also provided are additional example embodiments, some, but not all of which, are described hereinbelow in more detail.

### BRIEF DESCRIPTION OF THE DRAWINGS

The patent or application file contains at least one drawing executed in color. Copies of this patent or patent application publication with color drawings will be provided by the Office upon request and payment of the necessary fee.

The features and advantages of the example embodiments described herein will become apparent to those skilled in the art to which this disclosure relates upon reading the following description, with reference to the accompanying drawings, in which various examples of features are shown that can be used in any combination for any desired embodiment:

FIG. 1 shows a flow chart of one example embodiment of the platform showing the top level steps taken by an example content creator using in the example platform;

FIG. 2 is a chart that provides an example top-level reference to a number of the features and activities that are utilized when implementing one example embodiment of the editor;

FIG. 3A is a flow chart showing an example process Symbolated Editing;

FIG. 3B shows a screen shot of an example embodiment of a user selecting text in a text line to display the suggested list of symbols for the selected word;

FIG. 3C shows a screen shot of an example embodiment of selected symbol being displayed for the selected text of FIG. 3B;

FIG. 3D shows an example of an advanced symbol picker'

FIG. 3E shows a screenshot of an example embodiment of a function to bulk replace symbols in the document;

FIG. 4 shows a screenshot of an example embodiment of the editor showing a document being created within a web browser;

FIG. 5 is a flow chart showing an example process of opening an idoc;

FIG. 6 is a flow chart showing an example process of saving the content;

FIG. 7 is an example screen shot showing a more complex example symbolated document;

FIGS. 8A-8E show various example screen shots of an example of a “matching” interactive puzzle;

FIGS. 9A-9E show example screen shots presenting an example of another form of “matching” interactive puzzle;

FIGS. 10A-10C shows an example embodiment of the properties displayed in the property inspector;

FIGS. 11A-11B show example screen shots of an example of a “counting” puzzle;

FIGS. 12A-12C show example screen shots of another example of a “counting” puzzle;

FIGS. 13A-13C show example screen shots of inspectors used to configure the puzzle shown in FIGS. 12A-12C;

FIGS. 14A-14C show example screen shots of an example “Circle Answer” puzzle;

FIGS. 15A-15B show example screen shots in one example embodiment of the editor depicting how the puzzle shown in FIGS. 14A-14C was configured;

FIGS. 16A-16B show example screen shots in one example embodiment of the viewer showing a “Text Entry” puzzle;

FIG. 17 shows an example screen shot in an example embodiment of the editor depicting the property inspector used to configure the text shape used to receive input in FIGS. 16A and 16B;

FIGS. 18A-18D show example screen shots in an example embodiment of the viewer showing an example of a “Circle Multiple” puzzle;

FIGS. 19A-19B show example screen shots in an example embodiment of the editor depicting the inspector used to configure the puzzle shown in FIGS. 18A-18D;

FIG. 20 shows an example screen shot of one example embodiment of the editor in speech ordering mode;

FIG. 21 shows an example screen shot of one example embodiment of the editor in speech ordering mode;

FIG. 22 shows an example screen shot of the editor showing an example document illustrating various supported shapes as well as the toolbar;

FIGS. 23A-23I show various example depictions of inspectors for the named shapes in an example embodiment of the editor;

FIG. 23J shows an example screen shot of the editor showing properties displayed in the property inspector when multiple shapes are selected;

FIG. 23K shows an example screen shot of one example embodiment of the editor of the menu displayed for adjusting the stacking order (or Z-Order) of a selected shape;

FIG. 24A shows an example screenshot of an example embodiment of the reorder page dialog in the editor;

FIGS. 24A-24C collectively show an example process of adding a virtual page;

FIG. 24D shows an example result of the table of contents display in one embodiment of the viewer;

FIG. 25 shows an example screen shot of one example embodiment of the navigation toolbar in the editor;

FIGS. 26A and 26B show example screen shots of an example embodiment of the inspector settings;

FIG. 26C shows an example screen shot of an example embodiment of the viewer having a document loaded and displaying its table of contents;

FIG. 27 shows an example screen shot of an example embodiment of the editor showing it in the annotations mode;

FIG. 28 shows a flowchart of an example process by which a bitmap image can be added to a document;

FIG. 29 shows a high-level flowchart of the publishing process;

FIG. 30 shows a flow chart that provides an example top-level reference to the features and activities by one example embodiment of the viewer;

FIG. 31 shows a high-level architectural diagram of an example embodiment of a cloud-hosted solution;

FIG. 32 shows a more detailed architectural diagram of the example embodiment shown in FIG. 31;

FIG. 33a shows a screen shot of regular page as created in one example embodiment of the editor;

FIG. 33b shows a screen shot of the page template;

FIG. 34 shows an example screen shot of the property inspector;

FIG. 35a, shows a screen shot of an example menu;

FIG. 35b shows the dialog for selecting a page template;

FIG. 36 shows another screen shot of the property inspector;

FIG. 37 shows a screen shot of graphics handles;

FIG. 38 shows a screen shot of a suggested list of alternative spellings;

FIG. 39 shows a screen shot of a documents list as lessons;

FIG. 40 shows a screen shot of the navigation toolbar;

FIG. 41 shows a screen shot of a document loaded in the viewer;

FIG. 42 shows a progression of screen shots across time as each word is spoken using text to speech;

FIG. 43 shows examples of progression of screen shots where each of three lines of text is read aloud by text to speech, word-by-word;

FIG. 44 shows an example screen shot of the speech settings dialog in the editor;

FIG. 45 shows an example of the puzzle capabilities in the context of an actual document;

FIG. 46 shows a screen shot of the viewer in the full-screen mode; and

FIG. 47 shows an example screen shot of the viewer after the Hide Symbols button was clicked; and

FIG. 48 shows an example hardware networked system for implementing one or more of the example embodiments disclosed herein.

### DETAILED DESCRIPTION OF EXAMPLE EMBODIMENTS

Disclosed is a Symbolated Document Creation & Publishing Process for use in the field of content creation and publication. Provided are a plurality of example embodiments, including, but not limited to, a platform whose functionality supports the document life cycle of interactive symbolated materials from content creation to publication to storage and retrieval, and to viewing by and interaction with the content consumer.

In at least some example embodiments is provided a browser based, cloud hosted software platform for creating and viewing interactive, speaking, symbolated documents (documents that explicitly relate graphical symbols to text in order to enhance reader comprehension of the material presented) that can be used by content authors and content publishers to provide interactive, multimedia reading experiences to content consumers without requiring desktop software, browser plugins or custom programming.

For content producers, the editor component of the platform enables a familiar “desktop publishing” experience, except that it occurs primarily or exclusively within the web browser, is useable from a desktop computer or mobile device, and does not require the installation of any software (other than the browser). Such a platform is adapted to provide functionality that supports pixel perfect, printable layouts, drawing of vector shapes, placement of bitmaps, rich typography, spellcheck, programming-free configuration of drag and drop interactive documents, configuration of text to speech, annotations, table of contents definition and symbolated text editing.

For content consumers, the viewer of the platform enables a familiar document viewing experience within the web browser, for documents published by content creators.

Also provided in at least some of the example platforms is functionality for displaying interactive, symbolated documents across all modern web browsers. This includes functionality for navigating the document using a symbolated table of contents, speaking a page or selected line of text using text-to-speech, interacting with puzzle, toggling the visibility of supporting symbols, maintaining document presentation fidelity with embedded fonts, and hi-resolution printing.

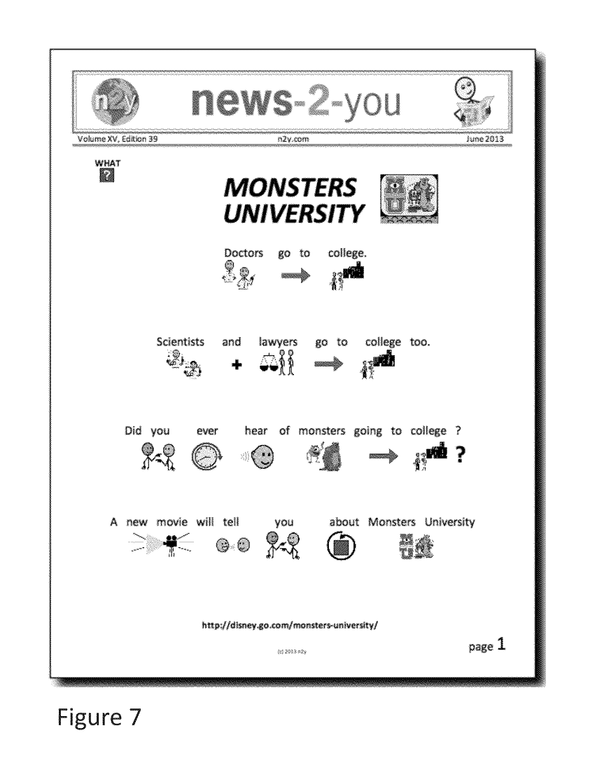

Provided are various examples of a platform whose functionality drives, manages and supports the document life cycle of interactive symbolated materials from content creation performed by content creators and authors to publication, to storage and retrieval, and to eventual viewing by and interaction with the content consumer. An example symbolated document is shown in FIG. 7.

This platform bifurcates its functionality in two component areas that provide distinct user experiences: an editor utilized by the content producers and a viewer utilized by the content consumers. Both experiences leverage common cloud infrastructure to support their functionality.

For content producers, the editor component enables a familiar “desktop publishing” experience except that it occurs exclusively within the web browser, is useable from a desktop computer or mobile device and which in many embodiments does not require the installation of any software (other than the standard browser provided by a number of different vendors, such as the Internet Explorer or Firefox browsers).

Also provided in at least some embodiments is functionality that supports pixel perfect, printable layouts, drawing of vector shapes, placement of bitmaps, rich typography, spellcheck, configuration of drag and drop interactive puzzles, configuration of text to speech, annotations, table of contents definition and symbolated text editing.

For content consumers, the viewer enables a familiar document viewing experience within the web browser, for documents published by content creators.

Also provide in at least some embodiments is functionality for displaying interactive, symbolated documents across all modern web browsers. This includes functionality for navigating the document using a symbolated table of contents, speaking a page or selected line of text using text-to-speech, interacting with puzzles and toggling the visibility of supporting symbols.

For example, a platform is provided that defines and utilizes a proprietary “idoc” document format that describes document content, layout and configuration using JSON. This format is a lightweight, text-based serialization of the document object model emitted by the editor and displayed by the viewer. Images and fonts are linked from the document, but stored separately. All “idoc” documents, images and fonts are stored using cloud resources, and the editor and viewer are accessed via a website.

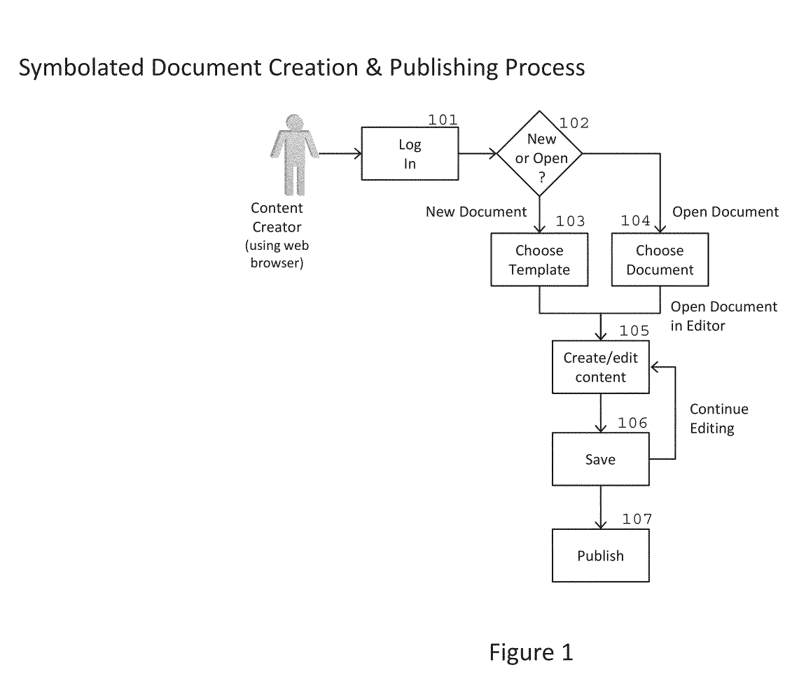

FIG. 1 shows a flow chart of one example embodiment of the platform showing the top level steps taken by an example content creator using in the example platform. Content creators can access the editor via a secured website login 101 over the Internet (e.g., a cloud-based system), for example, or alternatively such an editor might be hosted on a local machine. Content creators begin their content creation by choosing 102 between either starting with a new blank document or template 103, or choosing an existing document 104 that was previously created using the editor. They are then able to use all of the functions of the editor to create or edit 105 the interactive, symbolated document, and saving to the cloud 106 as often as desired. When the document is ready, the content creator is able to publish 107 the document which makes the document available for reading using the viewer accessed from the website.

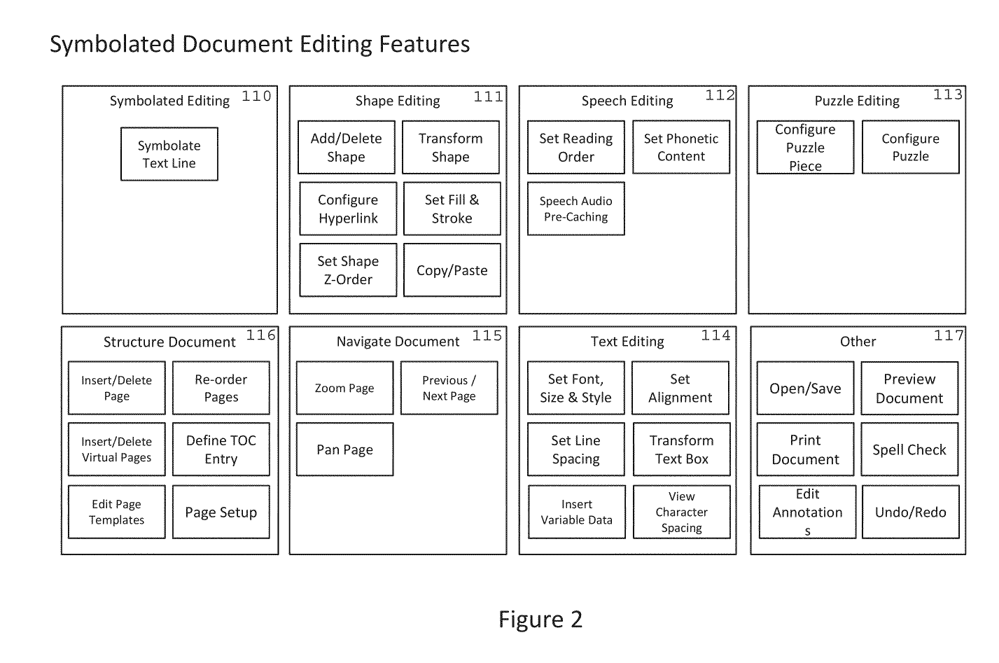

FIG. 2 is a chart that provides an example top-level reference to a number of the features and activities that are utilized when implementing one example embodiment of the editor. For example, the system provides for Symbolated editing 110 which permits editing of a symbolated text line.

Shape editing 111 is provided which allows for adding and deleting a shape, configuring a hyperlink, setting a shape Z-order, transforming a shape, setting fill and stroke, and copying and pasting. Speech editing 112 is provided for setting the reading order, setting the phonetic content, and for speech audio pre-caching. Puzzle editing 113. is provided to allow configuring a puzzle piece and configuring a puzzle. Text Editing 114 is also provided for setting fonts, setting alignment, setting line spacing, inserting variable data, transforming text boxes, and viewing character spacing.

Document Navigation 115 is provided to allow for page zooming, page panning, and previous/next page navigation. Document Structuring 116 is provided to allow inserting/deleting pages, re-ordering pages, inserting/deleting virtual pages, editing page templates, defining table of contents (TOC) entry, and for page setup. Finally, other functions 117 allowing opening and closing documents, previewing documents, printing documents, editing annotations, spell checking, and undo/redo functions are provided.

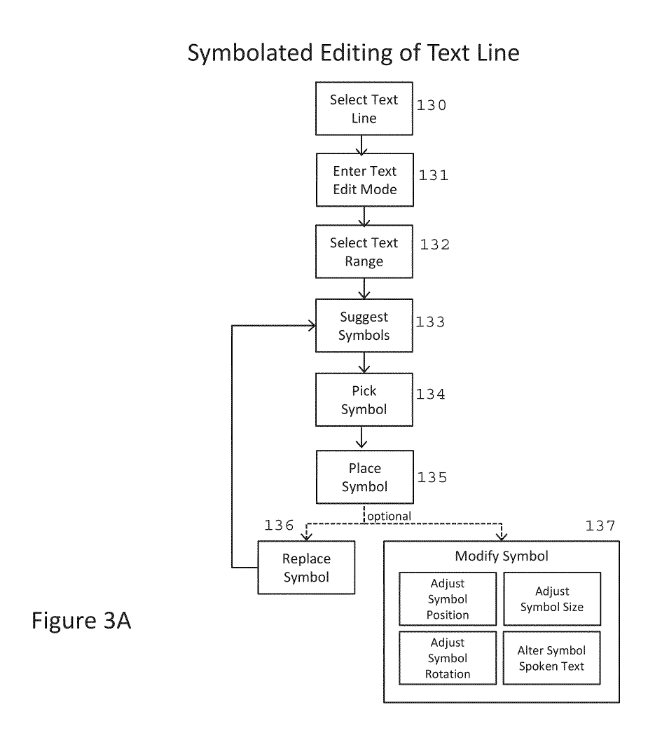

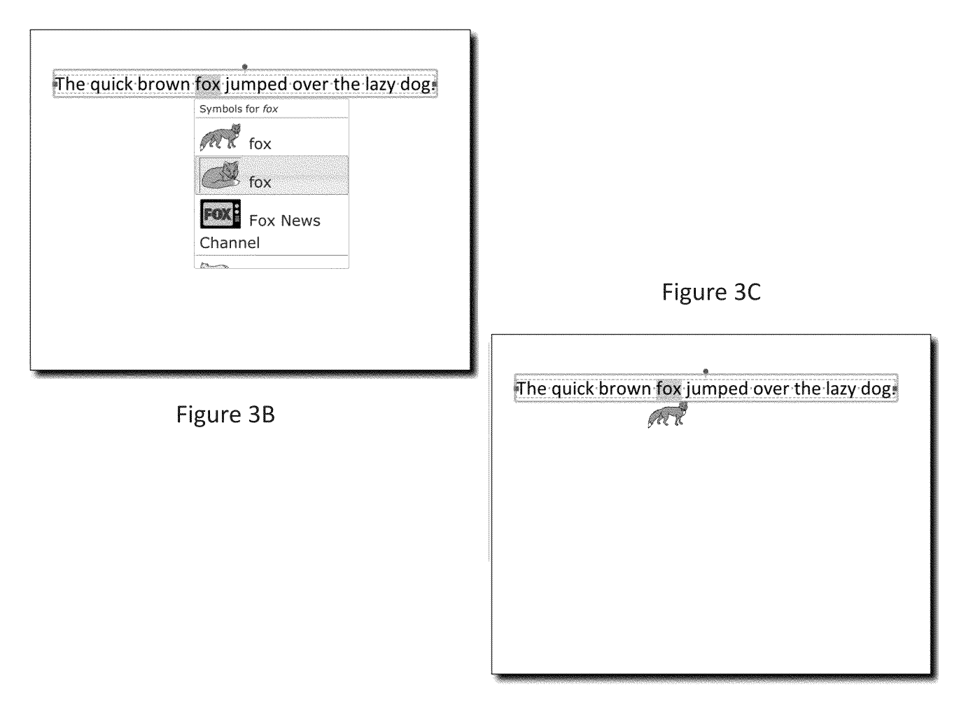

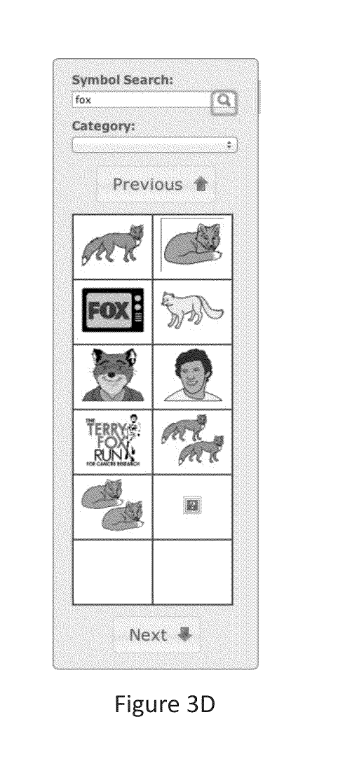

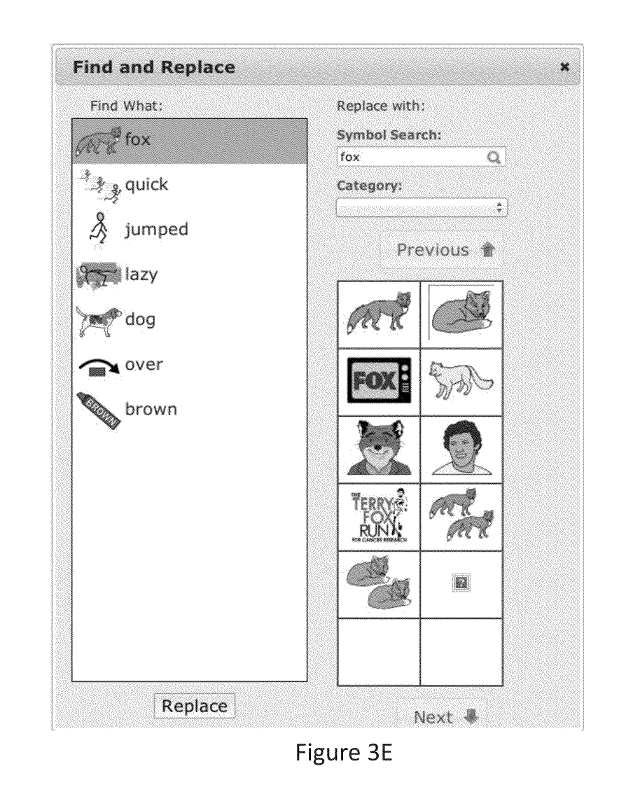

FIG. 3A is a flow chart showing an example process Symbolated Editing 110 for adding and editing symbols to a line of text in embodiment of the editor, including the functions of selecting a text line 130, entering a text edit mode 131, selecting the text range 132, picking a symbol 134, placing a symbol 135, and optionally replacing a symbol 136 and/or modifying a symbol 137 by adjusting its size, position, rotation, or altering its spoken text. Examples uses of these functions are shown in FIGS. 3B-3E.

FIG. 3B shows a screen shot of an example embodiment of a user selecting text in a text line to display the suggested list of symbols for the selected word “fox” in a menu, and FIG. 3C shows an example result after the user has selected the first option from the provided list, which shows various symbols that can represent the word “fox”. The user chooses the symbol that best matches the desired meaning (context).

FIG. 3D shows an example of an advanced symbol picker that can be displayed when the user chooses the “search more . . . ” option found at the end of the list of suggestions in 3B in an example embodiment. This embodiment enables the user to page through all of the available suggested symbols, and when selecting one of them, the chosen symbols is placed below the text similar to that shown in 3C.

FIG. 3E shows a screenshot of an example embodiment of a screen used to bulk replace all symbols in the document with another symbol, allowing symbol changes in an entire document using a single change process. The greatly simplifies updating document symbols. Note that the window on the left shows all symbols being used in the document, and when selected, the menu on the right shows potential replacement symbols.

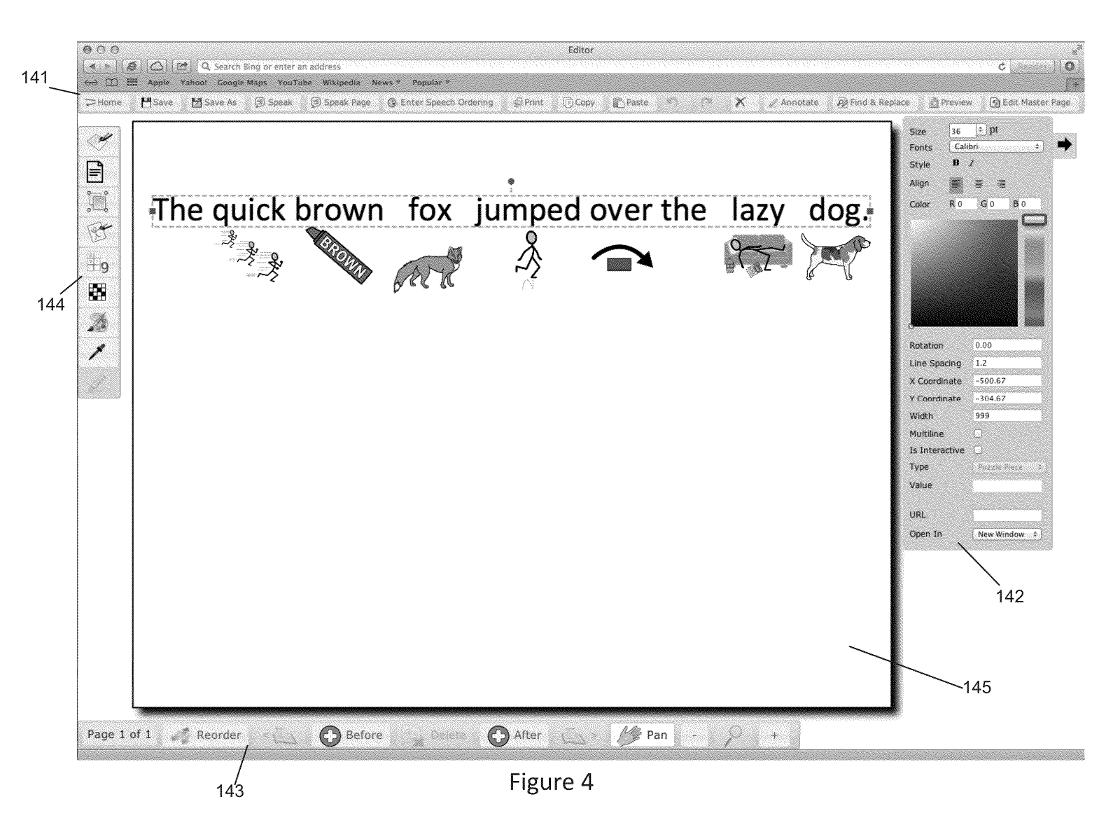

FIG. 4 shows a screenshot of an example embodiment of the editor showing a document 145 being created within a web browser, and showing four toolbars around the document. In clockwise order from the top, they are main toolbar 141, a property inspector 142, a navigation toolbar 143 and a shapes toolbar 144. Note the explanatory symbols that are provided linked to the text line shown in the document, with running stick figures representing “quick”, a brown marker (or crayon) representing “brown”, an animal fox representing “fox”, a jumping stick figure representing “jump”, an arrow over a box representing “over” a stick figure lounging on a couch with snacks representing “lazy” and an animal dog representing “dog” In the example shown in the Figures, the explanatory symbols are graphical pictures that are provided under the respective words with which they are associated, but the symbols could be shown over the respective words, or next to the words, for example In particular, words that are nouns and verbs, and in some embodiments along with adverbs and adjectives, can be provided with symbols. Common words like “the”, “and”, “or” “a” and “an”, for example, typically would not require symbols, and hence in at least some embodiments, not every word in every sentence will be provided with an associated symbol.

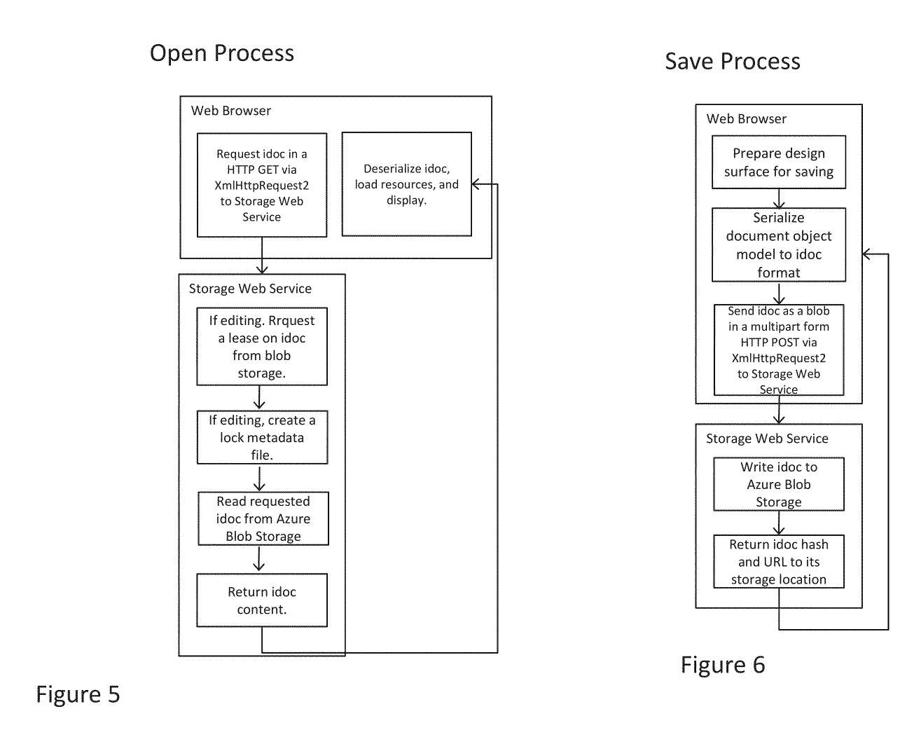

FIG. 5 is a flow chart showing an example process of opening an idoc (an SAP document format) in one embodiment of the editor. The idoc requested returns a JSON serialized object that the browser deserializes into a variable and then loads. As a part of the request against the storage web service, a lock is taken out on the idoc file and a lock file is placed in cloud blob storage next to the idoc. The former is used to prevent simultaneous users from editing the same document and the latter indicates metadata about the user has the document open. The lock is released after a period of inactivity or when the content creator closes the document.

FIG. 6 is a flow chart showing an example process of saving the content created in one example embodiment of the editor using an idoc format using multipart forms. The content can be saved in the cloud, for example.

FIG. 7 is an example screen shot showing a more complex example symbolated document created using the example embodiment described above. Note the extensive use of symbols to represent the text.

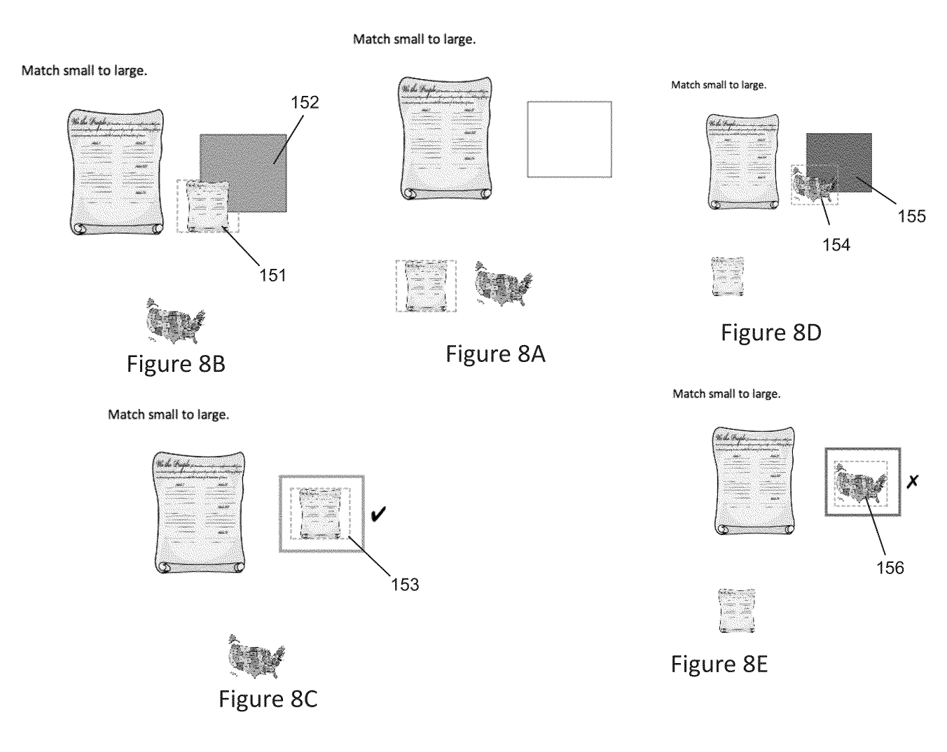

FIGS. 8A-8E show various example screen shots of an example of one form of a “matching” interactive puzzle created in one embodiment of the editor, being manipulated by a user of one embodiment of the viewer. In FIG. 8A the puzzle is in the initial unsolved state. The puzzle is to match one of the smaller objects to the large object. In FIG. 8B, the content consumer has selected 151 one of the puzzle options and dragged it over the drop zone 152, which changed color to green to indicate it is the right option. FIG. 8C shows what happens when the content consumer has dropped the correct shape in the target 153. In FIGS. 8D and 8E the wrong shape 154 is dragged over the drop target 155 which changes color to red, and then dropped, respectively, showing a failure 156.

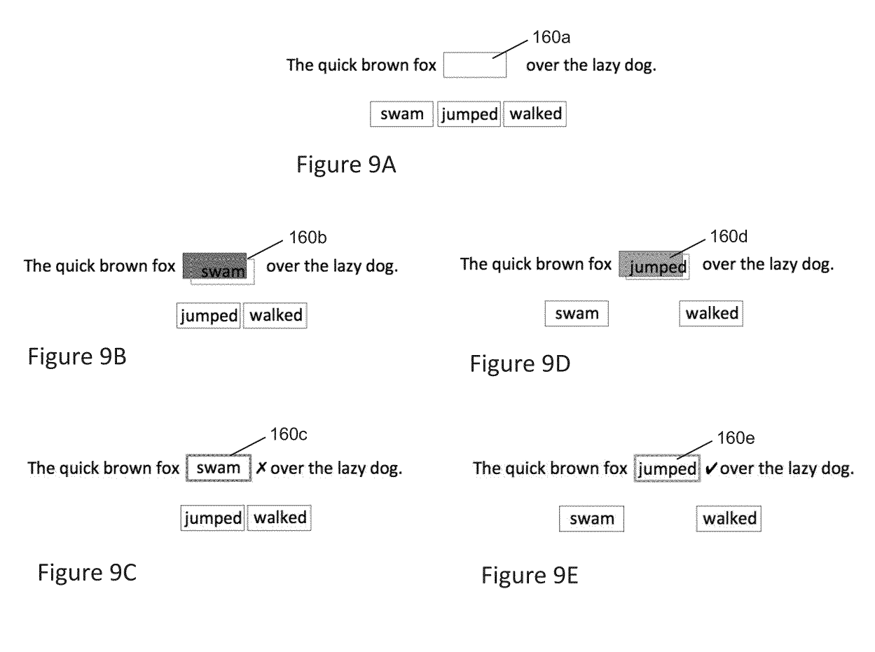

FIGS. 9A-9E show example screen shots presenting an example of another form of “matching” interactive puzzle used in one embodiment of the viewer, this one exemplifying a word bank from which a content consumer selects a word bank, drags, and drops it into a rectangle 160a representing the “blank space”. Again, FIG. 9A shows the start of the puzzle, FIGS. 9B and 9C show a result of selecting and placing an improper solution in boxes 160b, 160c, respectively, while FIGS. 9D and 9E show the results of selecting and placing a correct solution in boxes 160e, 160e, respectively.

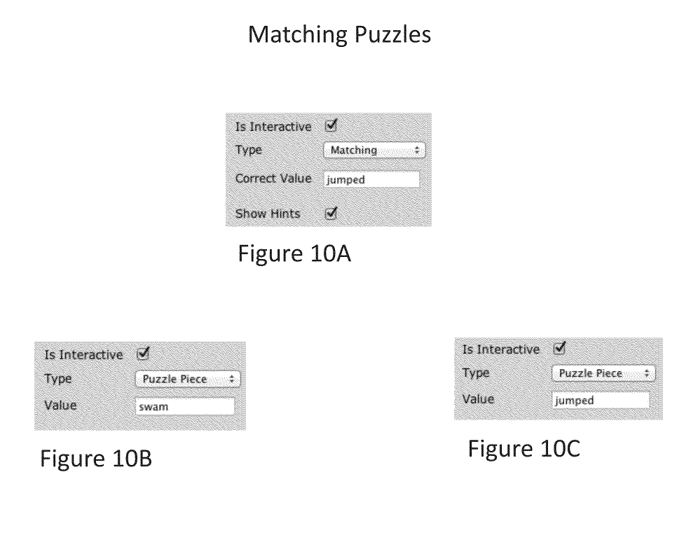

FIG. 10A shows one example embodiment of the properties displayed in the property inspector (item 142 in FIG. 4), when the rectangle representing the “blank space” in FIG. 9A is selected by the content creator. In this embodiment of the editor, any shape added to the design surface can be turned into an interactive shape that becomes a part of a puzzle. In FIG. 10A, the rectangle has its “Is Interactive” checkbox checked, which enables configuration of the interaction (and therefore the puzzle), which in FIG. 10A is for “matching”. A puzzle of this type has two components: a drop target, which is the “blank space” rectangle 160a of FIG. 9A and puzzle pieces, which are the groups consisting of a text box and a rectangle grouped together to form the word bank in FIG. 9A.

“Matching” puzzles have two options, a correct value (the value that a puzzle piece dropped into it must have in order to be considered correct) and show hints (which controls when the shape changes color to indicate a right or wrong answer—when the user is dragging a puzzle piece into the shape or only after dropping the puzzle piece). In FIG. 10A the expected correct value is the word “jumped”. 10B shows the configuration for one of the incorrect word bank options 9B, and 100 shows the configuration of a correct word bank option in the context of 9D. In both cases, “Is Interactive” is checked and the type is set to “Puzzle Piece”, which indicates the piece has a value and that it can be dragged and dropped into another interactive shape.

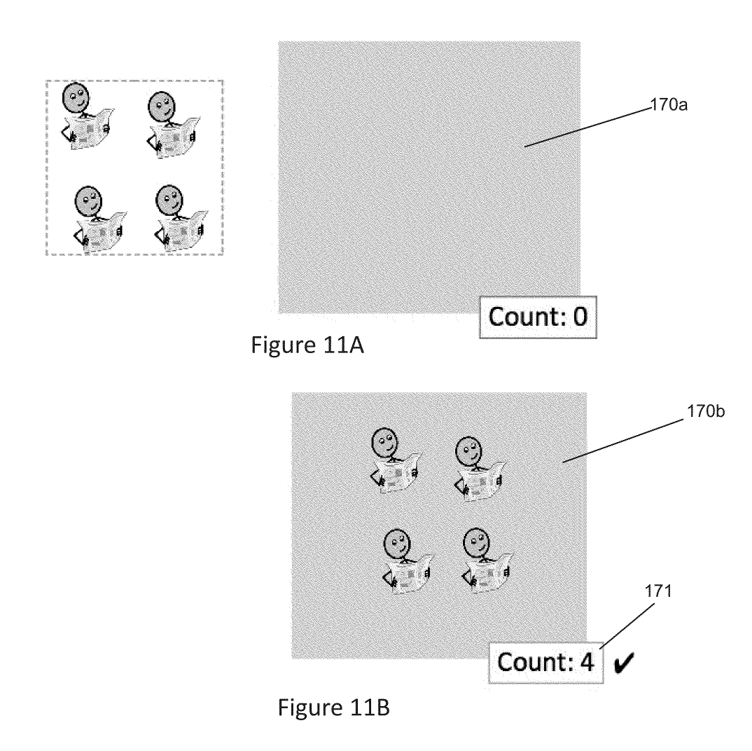

FIGS. 11A-B show example screen shots of an example of a “counting” puzzle created in one embodiment of the viewer. In FIG. 11A, a group of four shapes is dragged into a rectangle 170a. In FIG. 11B the group is dropped within the rectangle 170b and the Count value 171 is updated.

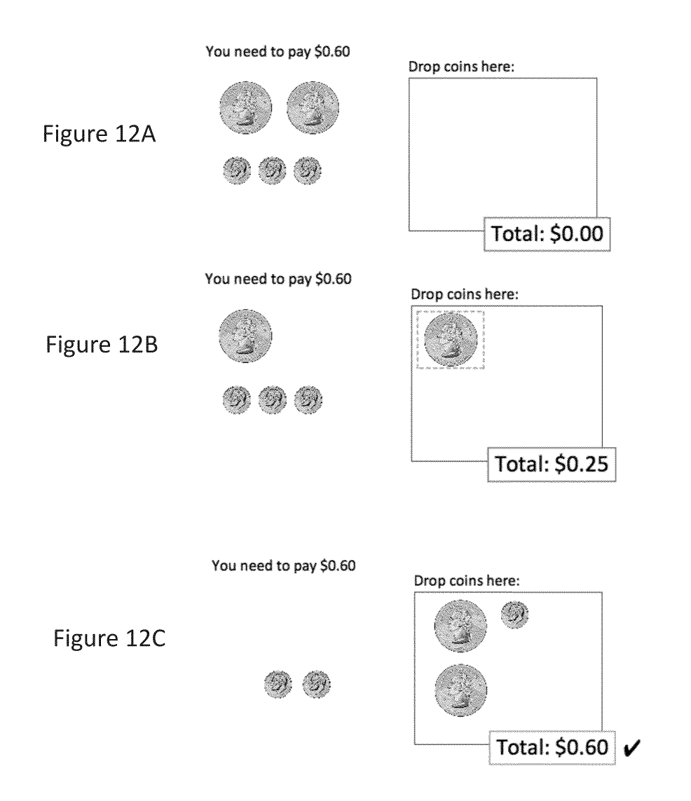

FIGS. 12A-12C show example screen shots of another example of a “counting” puzzle. In this case, the count is formatted to display as currency. FIG. 12B shows progress towards solving the puzzle and FIG. 12C shows the result when the puzzle is solved.

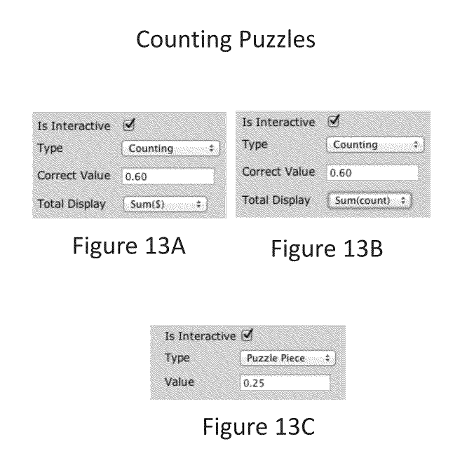

FIGS. 13A-13C show example screen shots of inspectors of one embodiment of the editor used to configure the puzzle shown in FIG. 12. FIGS. 13A and 13B show how the rectangle drop target is configured as a “Counting” puzzle by setting its Type, and the expected value that displays the result of FIG. 12C by setting the Correct Value. The format of display is controlled by the Total Display option, where “Sum($)” yields the display shown in FIG. 12A and “Sum(count)” yields the display shown in FIG. 11A. The symbol depicting a quarter shown in FIG. 12A is configured to be interactive with the “Is Interactive” checkbox set with a Type of “Puzzle Piece” and a Value of 0.25. This results in a value of $0.25 being displayed when the quarter is dropped into the drop target as shown in FIG. 12B.

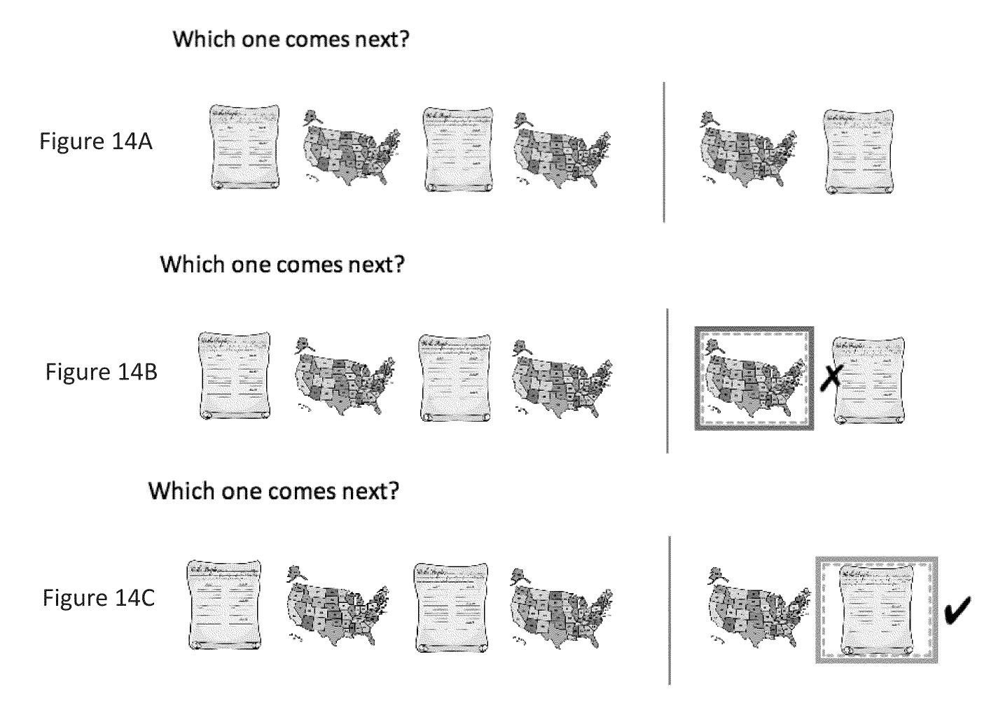

FIGS. 14A-14C show example screen shots of an example “Circle Answer” puzzle in an embodiment of the viewer. In FIG. 14B, the content consumer has clicked on the symbol of the USA map, which was the incorrect answer. In FIG. 14C the content consumer has clicked on the symbol of the Constitution, which was the correct answer.

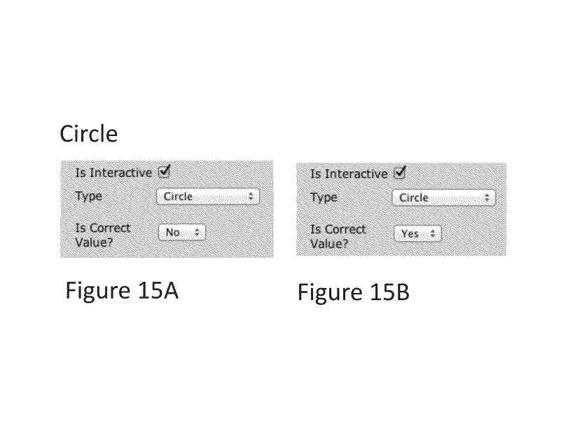

FIGS. 15A-15B show example screen shots in one example embodiment of the editor depicting how the puzzle shown in FIGS. 14A-14C was configured. In FIG. 15A, the shape that is the wrong answer shown in FIG. 14B is configured with the Type “Circle” and Is Correct Value of “No”. In FIG. 15B, the same Type is used but Is Correct Value is set to “Yes” to achieve the result shown in FIG. 14C when the user clicks on it.

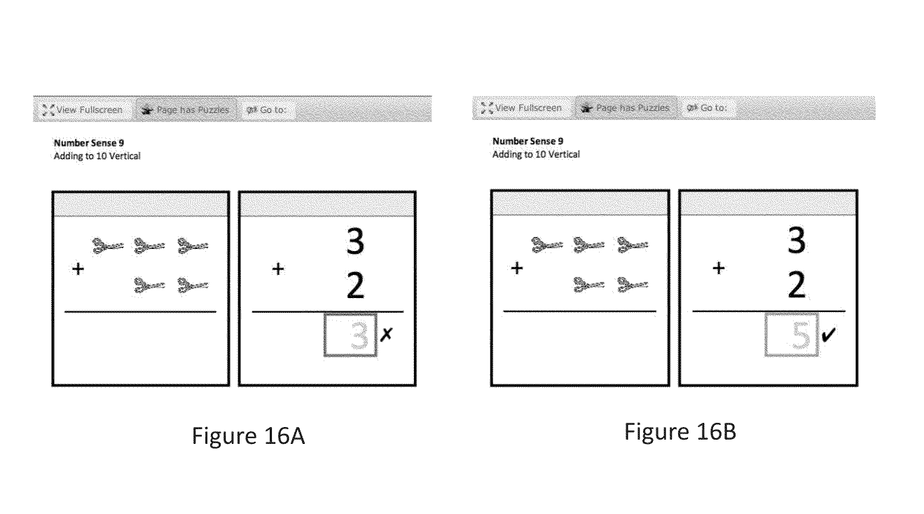

FIGS. 16A-16B show example screen shots in one example embodiment of the viewer showing a “Text Entry” puzzle. In FIG. 16A, the user has entered the incorrect text value. In FIG. 16B, the user has entered the correct text value.

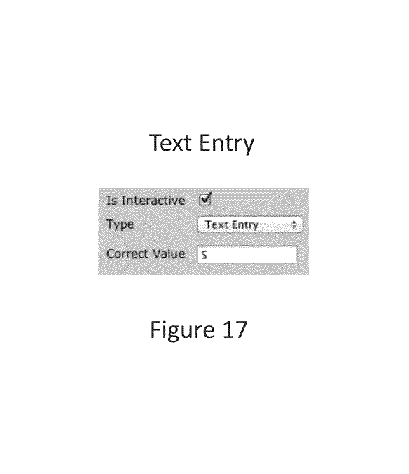

FIG. 17 shows an example screen shot in an example embodiment of the editor depicting the property inspector used to configure the text shape used to receive input in FIGS. 16A and 16B. In this case, its Correct Value is set to “5” to indicate that is the value the content consumer must type in to get the display to indicate the correct answer shown in FIG. 16B when running the puzzle in the viewer. Any other entry, results in the incorrect display shown in FIG. 16A.

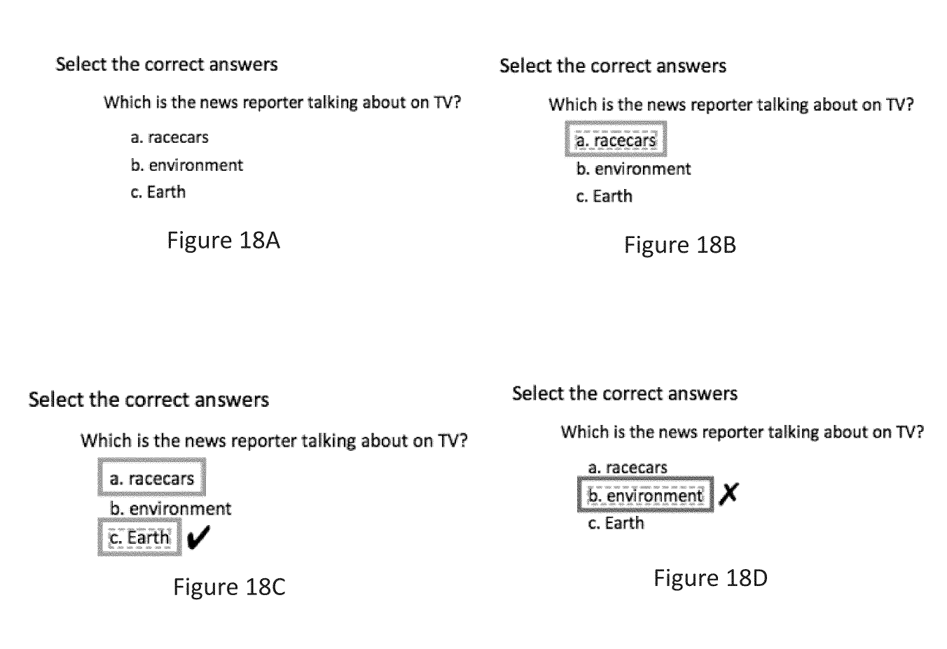

FIGS. 18A-18D show example screen shots in an example embodiment of the viewer showing an example of a “Circle Multiple” puzzle. FIG. 18A shows the puzzle initial state. FIG. 18B shows the result of selecting one of the two correct answers. FIG. 18C shows the result of selecting both correct answers. FIG. 18D shows the result of selecting the incorrect answer.

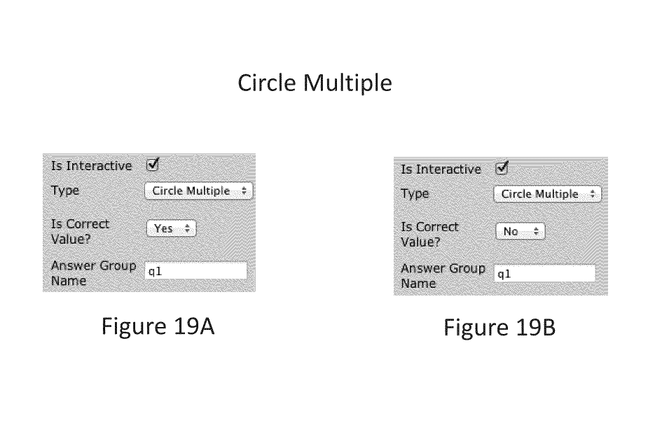

FIGS. 19A-19B show example screen shots in an example embodiment of the editor depicting the inspector used to configure the puzzle shown in FIGS. 18A-18D. FIG. 19A shows the configuration used for both the correct text boxes, by setting the “Is Correct Value” to “Yes”. FIG. 19B shows how the incorrect text box was configured by setting the “Is Correct Value” to “No”. In both cases the “Answer Group Name” is set to the same value (“q1” in this example) so that all three of the text boxes in selected form the options for the question.

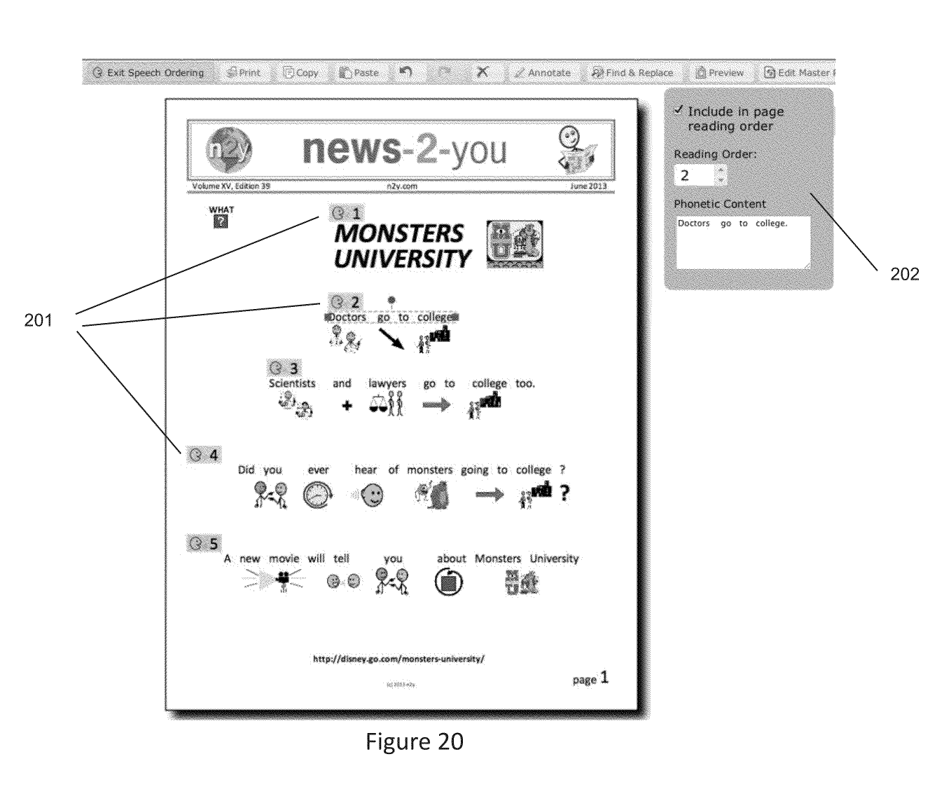

FIG. 20 shows an example screen shot of one example embodiment of the editor in speech ordering mode. In this mode, CTRL clicking on a line of text appends it to the reading order when the page is spoken using text-to-speech. CTRL and ALT clicking on a text quickly removes the text from the reading order. The reading order is indicated with a numeric tooltip floating near the top left corner of the text box 201. When selecting a single textbox, the property inspector 202 displays settings specific to text to speech. There is a checkbox for “Include in page reading order” to include the text line when reading the page using text-to-speech, “Reading Order” which controls the order in which lines are read. “Phonetic Content” is text that by default is set to the same value as the text line, but can overridden to provide the text to speech engine (in a manner specific to the engine used) additional hints on pronunciation and to adjust the duration of pauses.

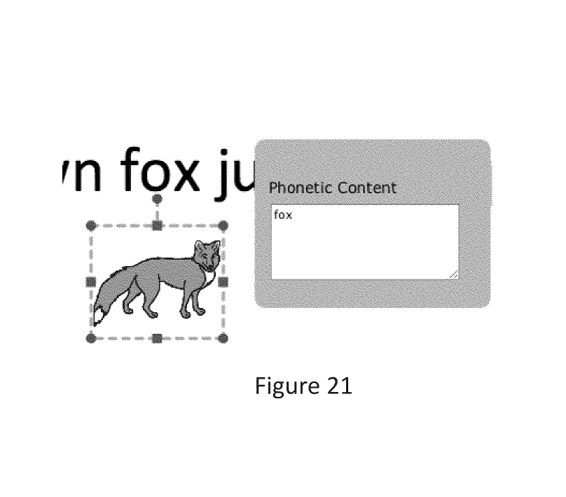

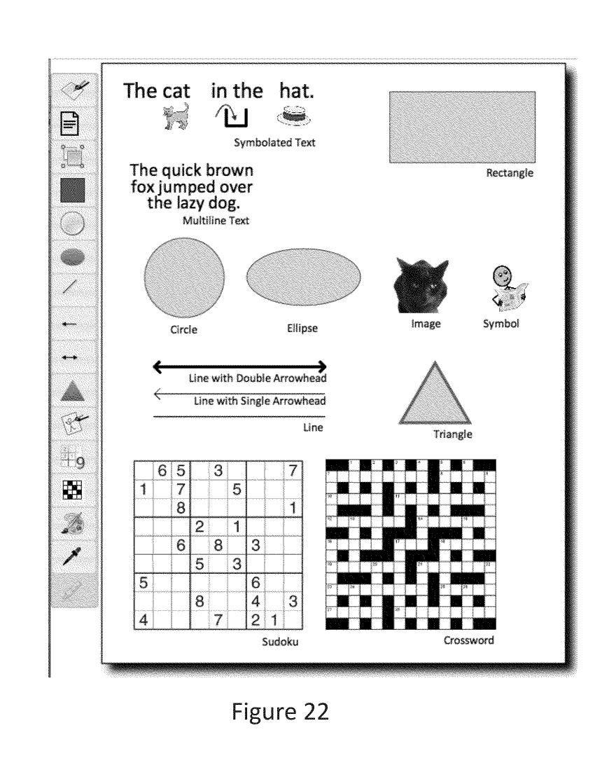

FIG. 21 shows an example screen shot of one example embodiment of the editor in speech ordering mode, showing how a symbol can also have alternative spoken text functions. FIG. 22 shows a screen shot of one example embodiment of the editor showing an example document illustrating potentially all of the supported shapes, as well as the toolbar that is used to select the shape to add to the page.

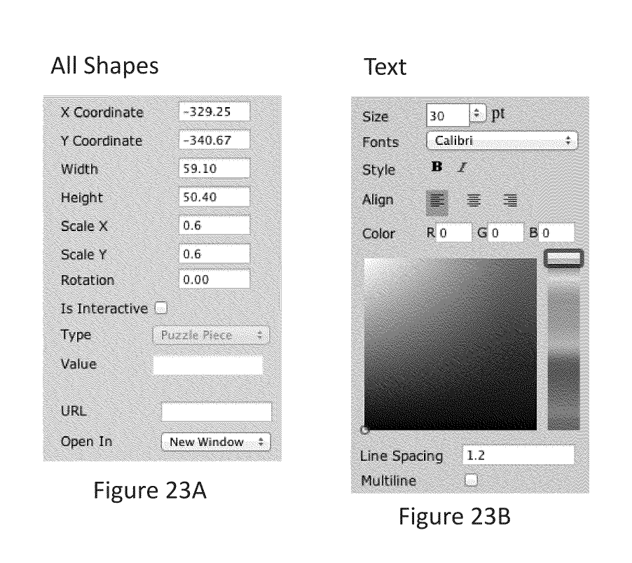

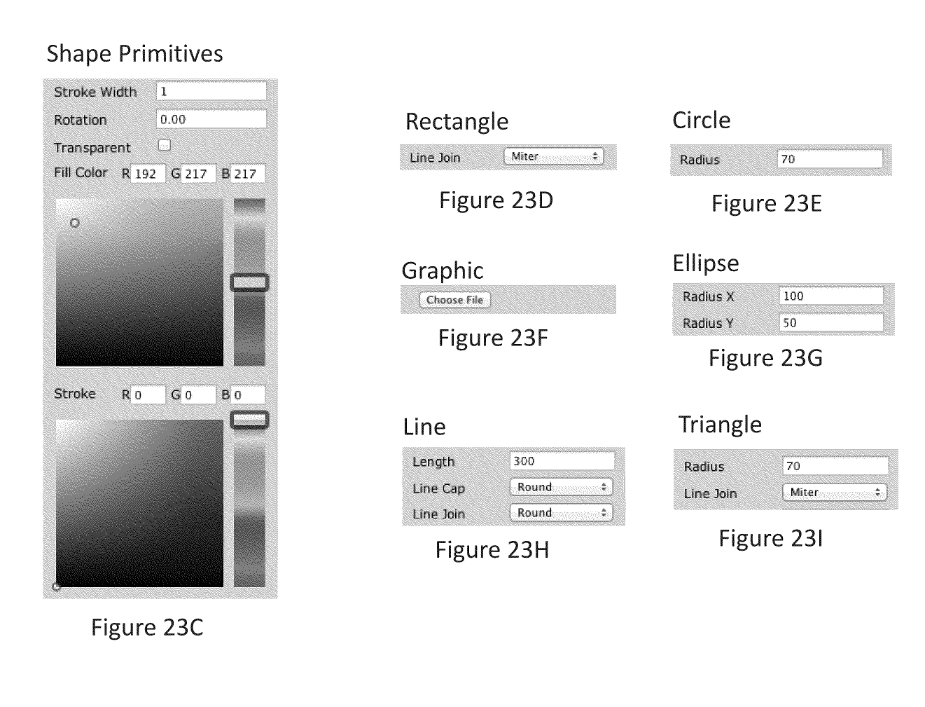

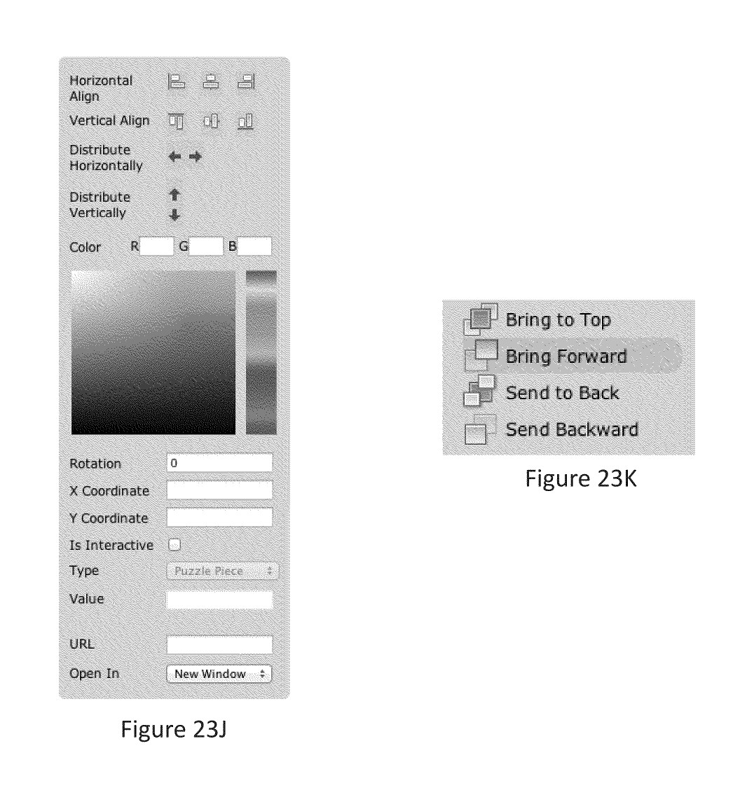

FIGS. 23A-23I show various example depictions of inspectors for the named shapes in an example embodiment of the editor. All shapes have the properties shown in FIG. 23A. Text lines (single and multi-line) have the properties shown in FIG. 23B. All shape primitives have the properties shown in FIG. 23C. FIGS. 23D-23I show the properties in addition to FIG. 23C that each shape named in the figure contains.

FIG. 23J shows an example screen shot an example in one example embodiment of the editor of the properties displayed in the property inspector when multiple shapes are selected—the properties common to the selected shapes are displayed. FIG. 23K shows a screen shot in one example embodiment of the editor of the menu displayed for adjusting the stacking order (or Z-Order) of a selected shape.

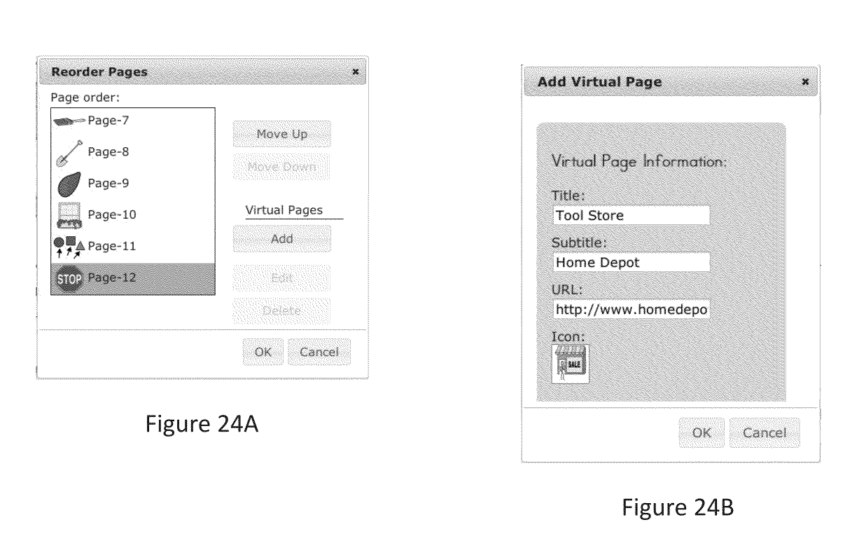

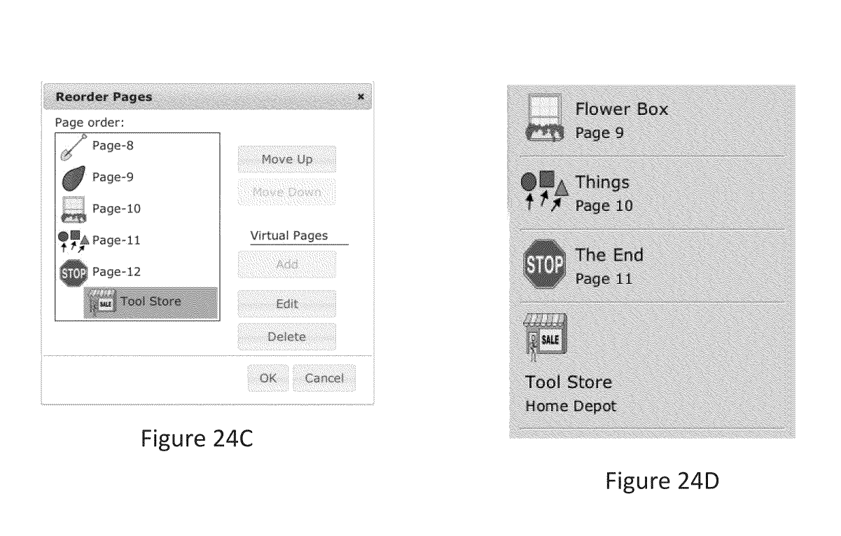

FIG. 24A shows an example screenshot of an example embodiment of the reorder page dialog in the editor, which serves two functions. One is to re-arrange pages within the document, and the other is to manage virtual pages.

FIGS. 24A-24C collectively show an example process of adding a virtual page (which enables a content creator to provide links to external documents within the table of contents) to a document in one example embodiment of the editor and FIG. 24D shows the result in the table of contents display in one embodiment of the viewer.

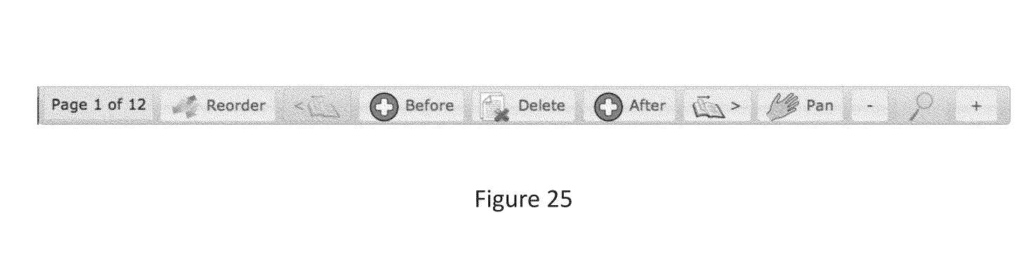

FIG. 25 shows an example screen shot of one example embodiment of the navigation toolbar in the editor.

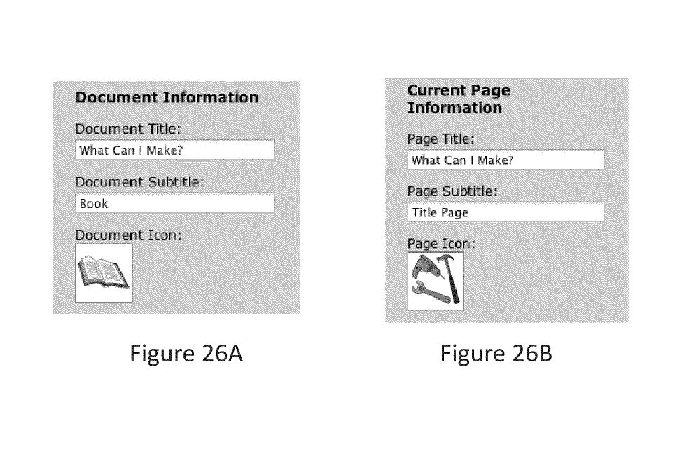

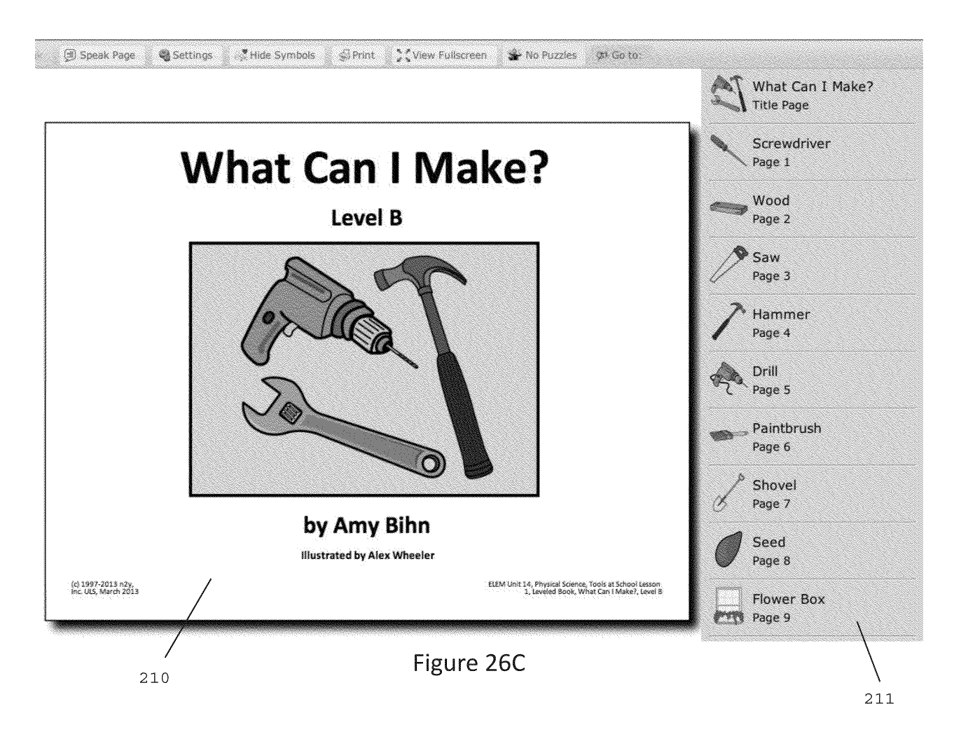

FIGS. 26A and 26B show example screen shots of an example embodiment of the inspector settings used to configure document metadata in the editor displayed when a page is selected. FIG. 26A shows how the document title, subtitle and icon are set. FIG. 26B is set for every page that should have an entry in the table of contents.

FIG. 26C shows an example screen shot of an example embodiment of the viewer having a document 210 loaded and displaying its table of contents 211 as configured with the inspector interfaces shown in FIG. 26A and FIG. 26B.

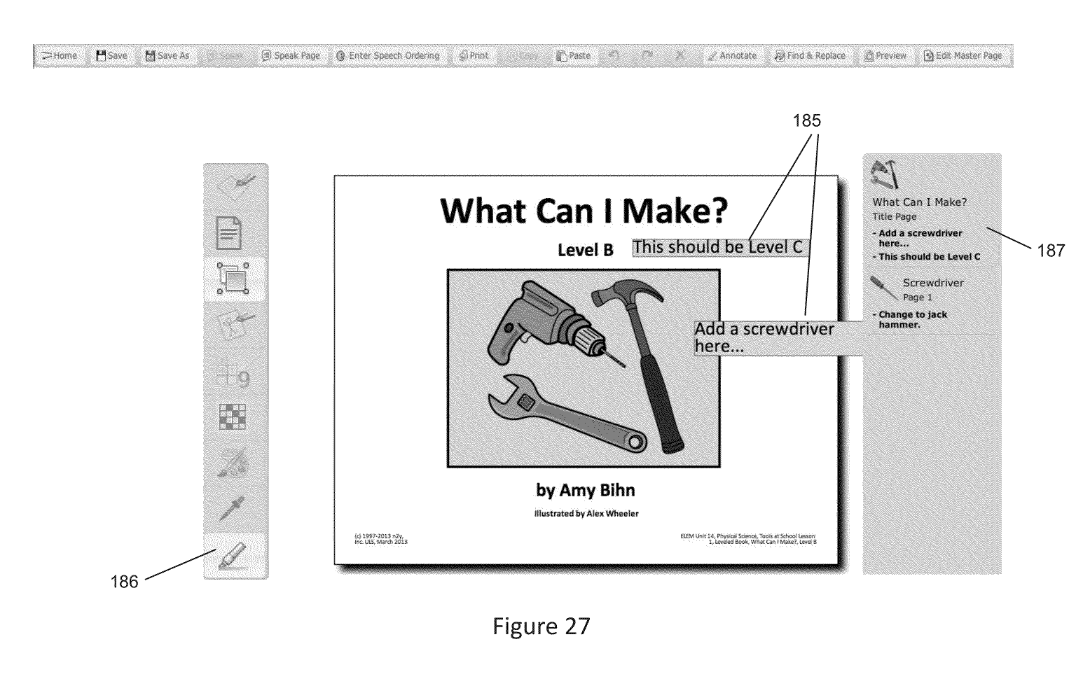

FIG. 27 shows an example screen shot of an example embodiment of the editor showing it in the annotations mode. Annotations 185 are added to the document using the annotation tool 186 (the bottom-most tool in the toolbar) and then it is edited just like a text box. Once added, annotations appear in a dialog 187 shown on the right. By clicking on an entry in that dialog, the user can quickly navigate to the page containing that annotation.

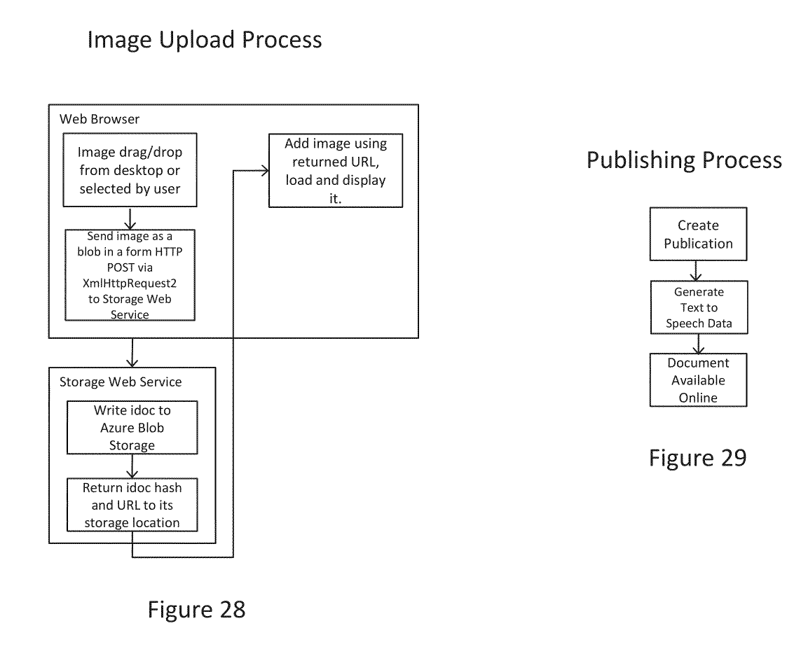

FIG. 28 shows a flowchart of an example process by which a bitmap image can be added to a document in an example embodiment of the editor. A content creator can drag an image from the desktop and drop it on the editor design surface, or use the graphic tool and then choose the file to insert the image.

FIG. 29 shows a high-level flowchart of the publishing process, in which the document is created, text to speech data is generated, and then the document is made available online.

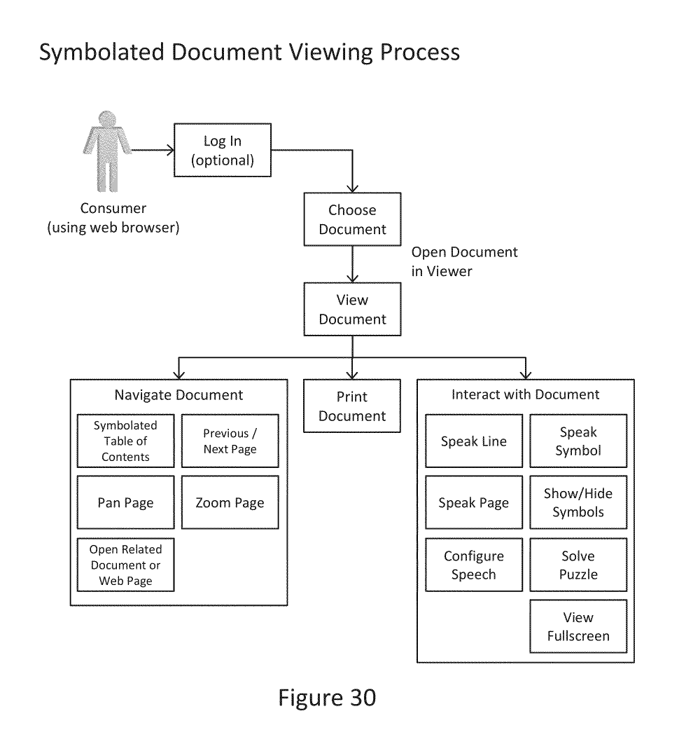

FIG. 30 shows a flow chart that provides an example top-level reference to the features and activities typically utilized when implementing one example embodiment of the viewer. The user logs into the application (typically using a web browser running on a personal computer or tablet, the user selects the document which is displayed for viewing, and the user can navigate the document, print the document, or otherwise interact with the document, as shown in the flow chart.

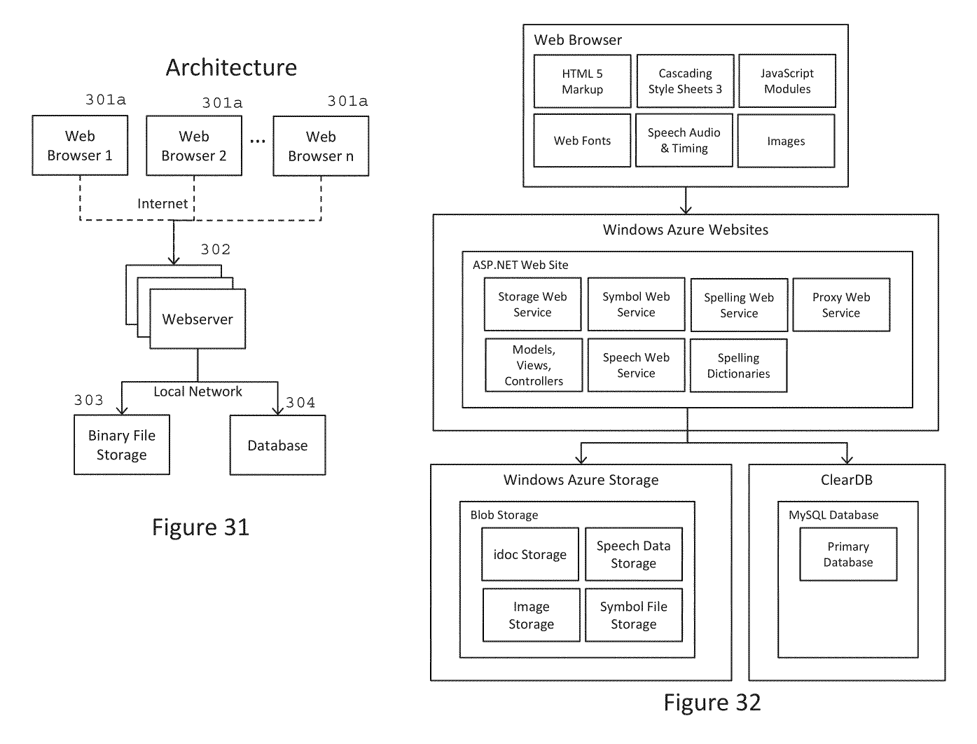

FIG. 31 shows a high-level architectural diagram of an example embodiment of a cloud-hosted solution. Content creators and content consumers access the application using the web browsers 301a, 301b, 301c available on a respective desktop or mobile device of the users. The web browser is communicating with the application that is hosted on one or more web servers 302, and in the process of servicing the user may access files from binary file storage 303 or records in a database 304, for example. FIG. 32 shows a more detailed architectural diagram of an example embodiment of the solution shown in FIG. 31.

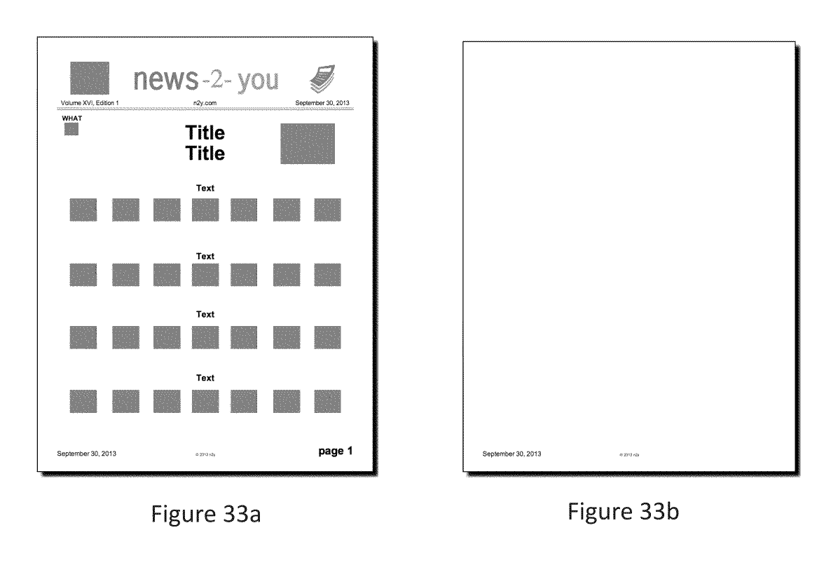

FIG. 33a shows a screen shot of regular page as created in one example embodiment of the editor. FIG. 33b shows a screen shot of the page template that was applied to the regular page in FIG. 33a to add footer information.

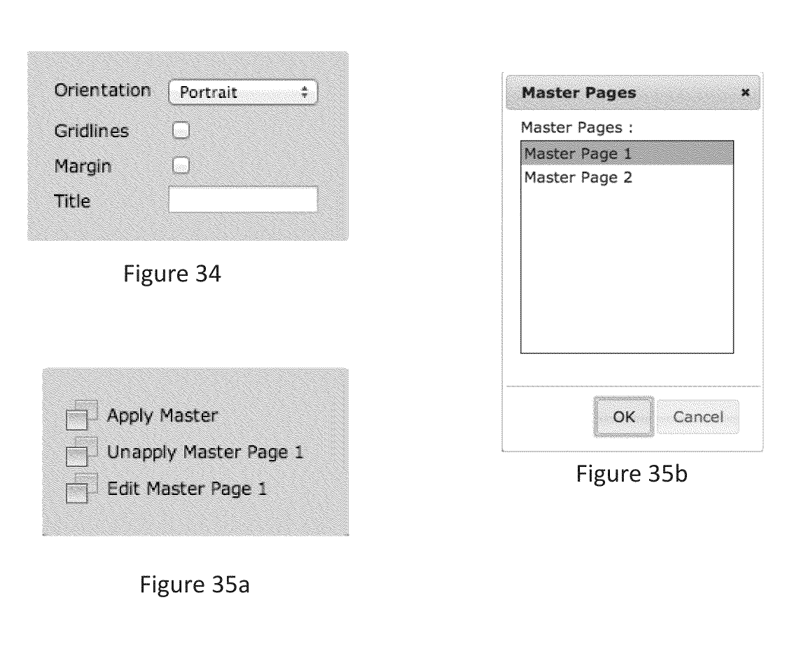

FIG. 34 shows a screen shot of the property inspector when a page is selected while editing a page template in one example embodiment of the editor. FIG. 35a, shows a screen shot of an example menu that appears when right clicking a regular page in one example embodiment of the editor. FIG. 35b shows the dialog for selecting a page template that appears when selecting “Apply Master” from the dialog in 35a.

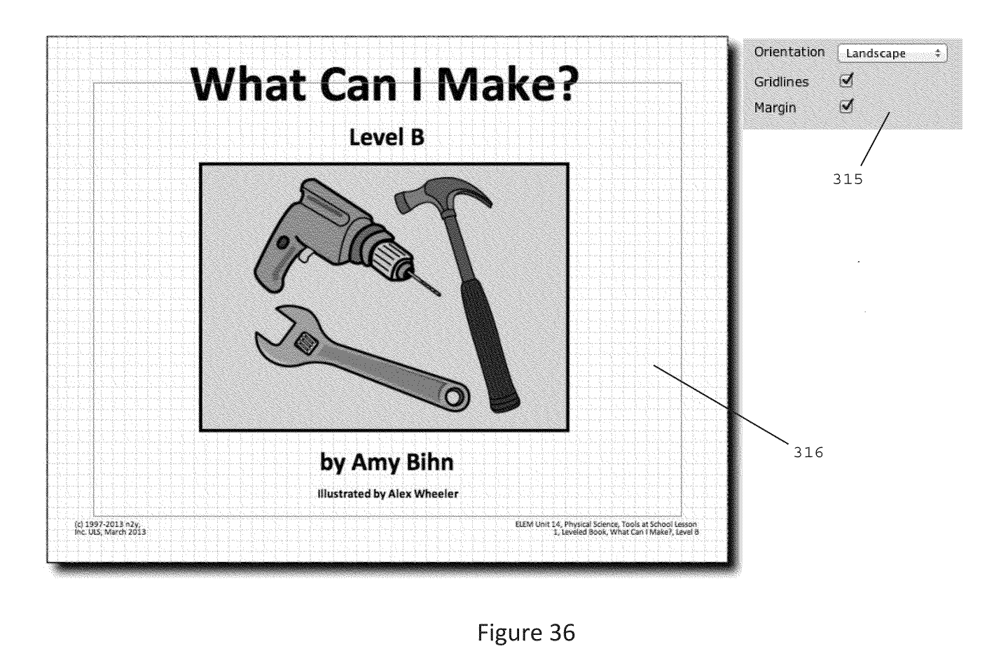

FIG. 36 shows the property inspector 315 that appears when a page 316 is selected in one example embodiment of the editor.

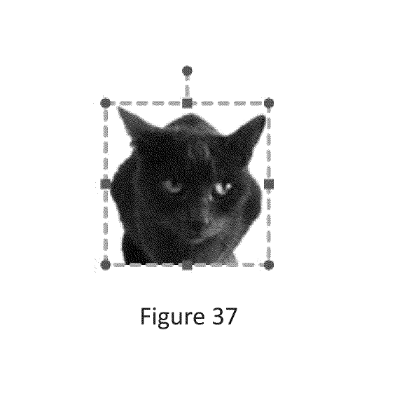

FIG. 37 shows a screen shot of the handles visible around a graphic shape selected in one example embodiment of the editor.

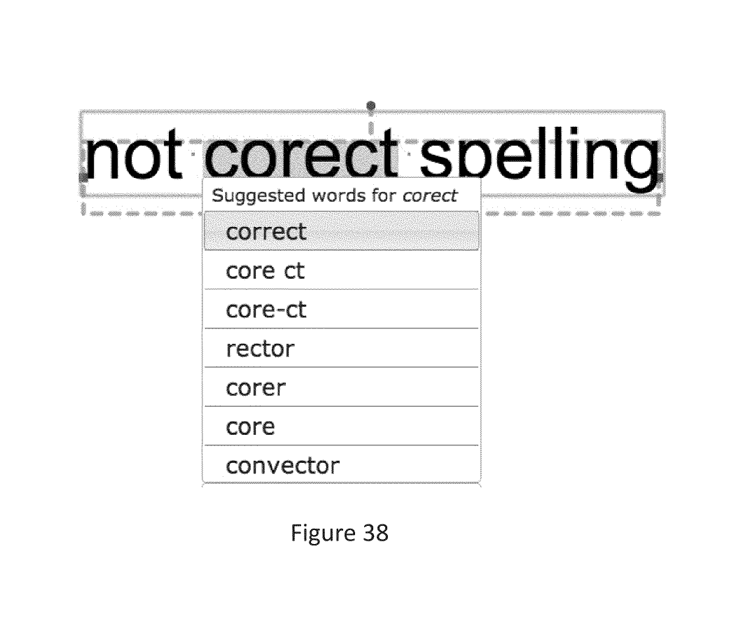

FIG. 38 shows a screen shot of a suggested list of alternative spellings for a word identified as misspelled in one example embodiment of the editor.

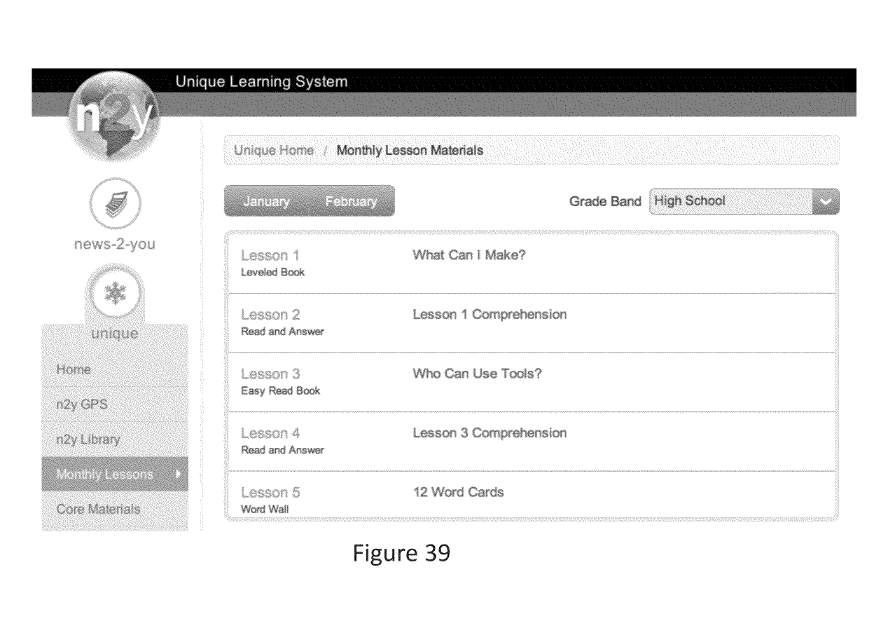

FIG. 39 shows a screen shot of one example embodiment that lists documents as lessons for the content consumer, visible once the document has been made available to content consumers by publishing.

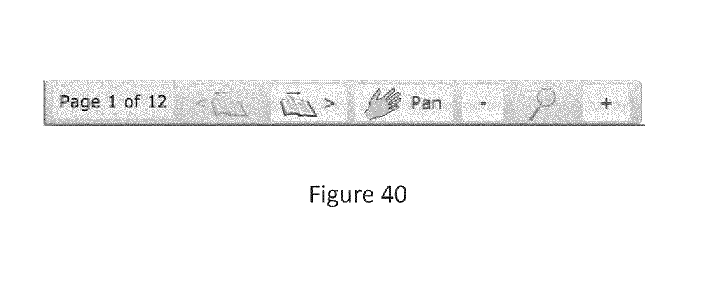

FIG. 40 shows a screen shot of the navigation toolbar within one example embodiment of the viewer.

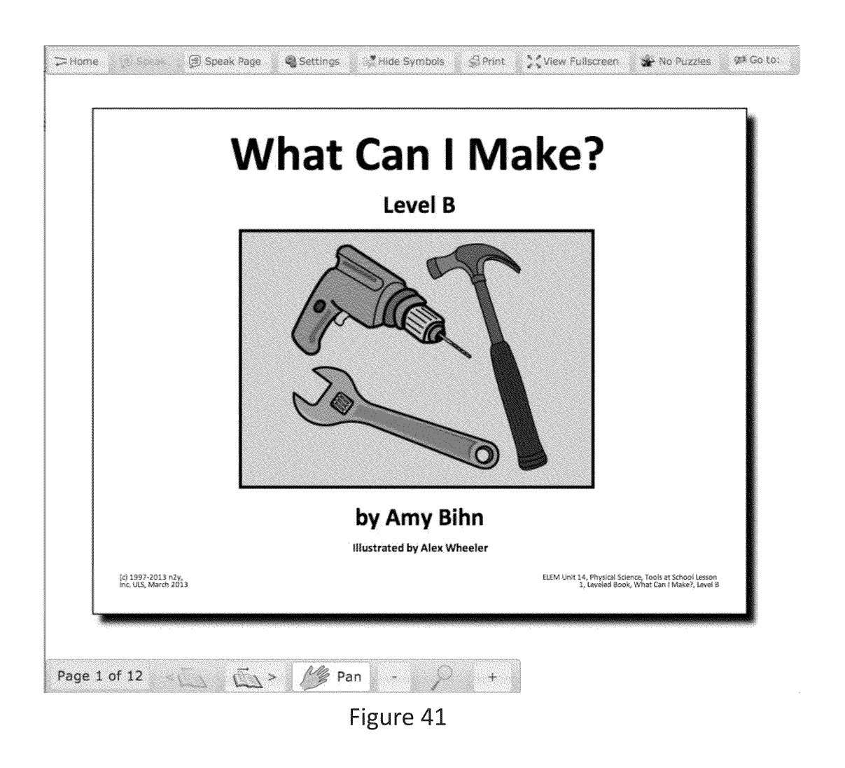

FIG. 41 shows a screen shot of a document loaded in one example embodiment of the viewer.

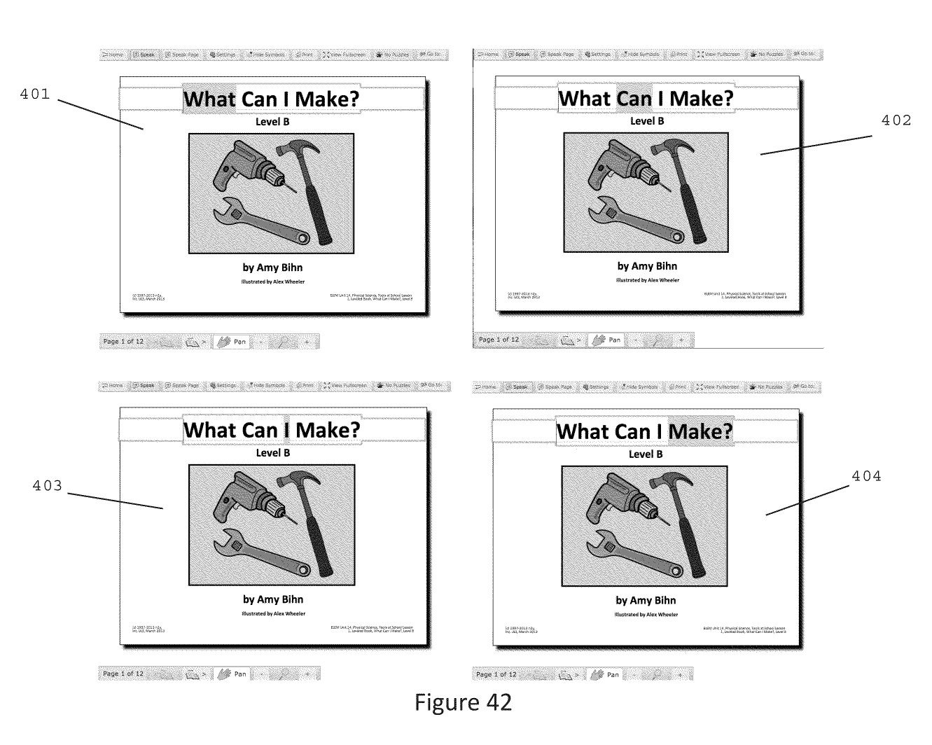

FIG. 42 shows a progression of screen shots 401-404 across time as each word is spoken using text to speech it is highlighted with a distinctive highlight color, in one example embodiment of the viewer. Thus, the word “what” is first highlighted 401 as it is spoken, then the word “can” is highlighted 402 as it is spoken, etc. until the last word “make” is highlighted 404 as it is spoken. In this manner, the viewer can follow the text as it is spoken.

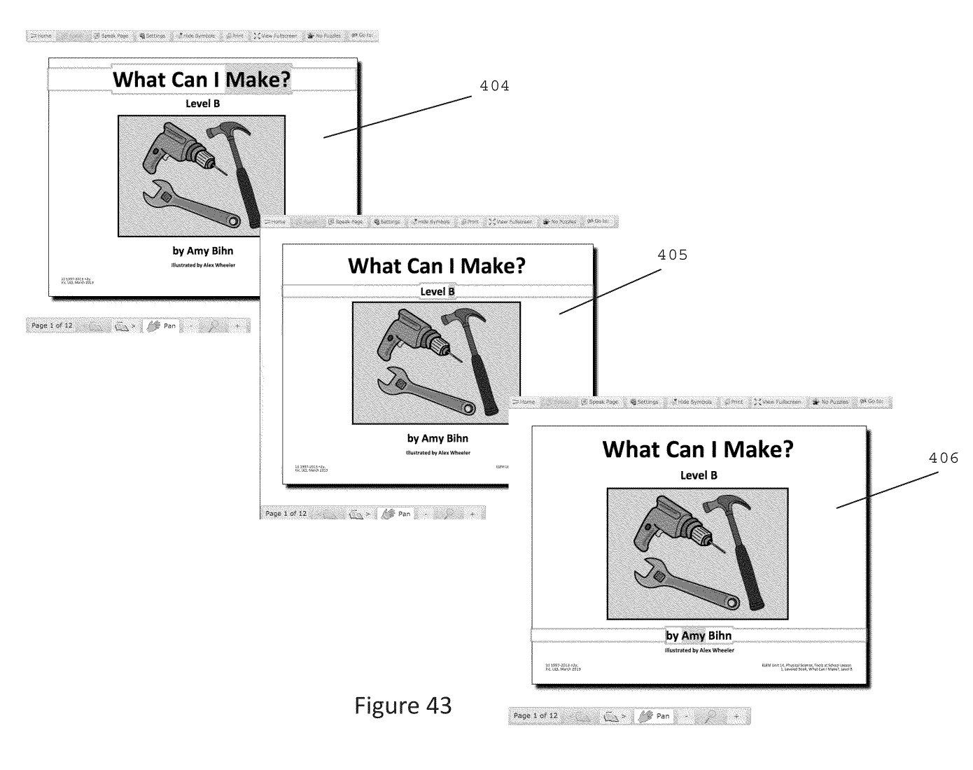

FIG. 43 shows examples of progression of screen shots 404-406 where each of three lines of text is read aloud by text to speech, word-by-word, and then the next line in the reading order is read, as shown by the highlights.

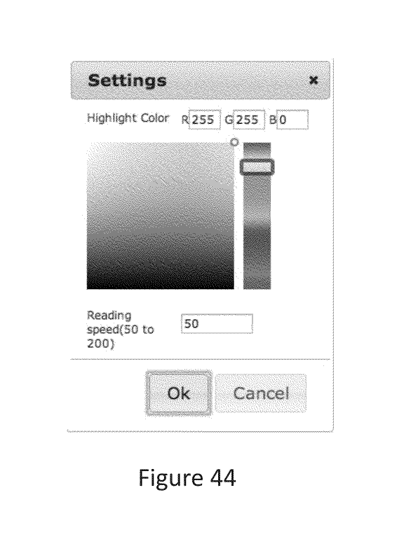

FIG. 44 shows an example screen shot of the speech settings dialog in an example embodiment of the editor, where the highlight colors and speech reading speed are adjustable.

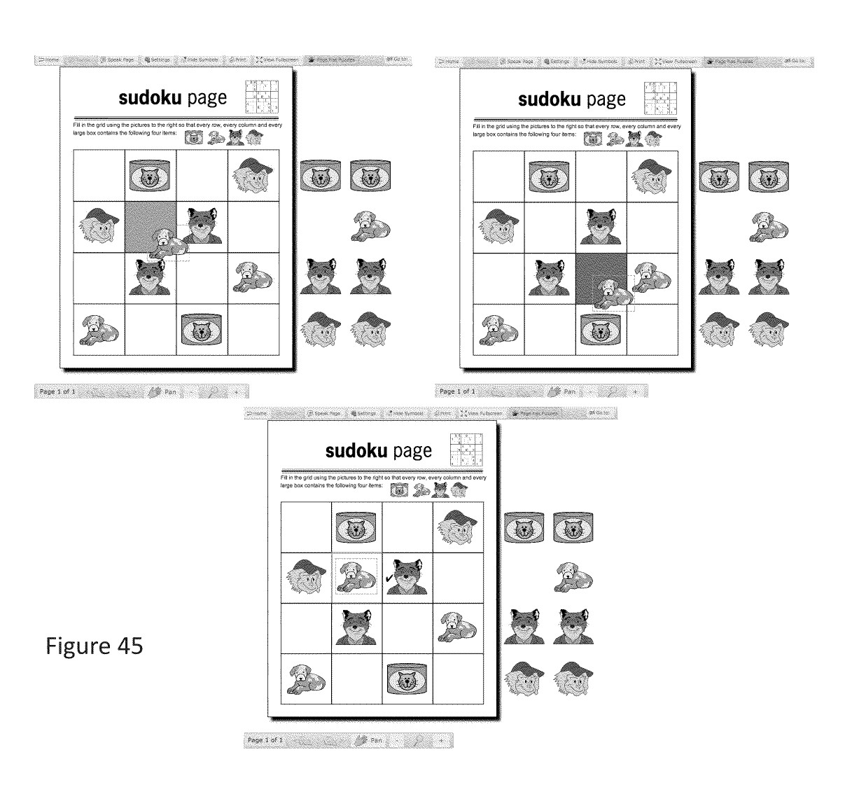

FIG. 45 shows an example of the puzzle capabilities in the context of real-world document loaded in a screen shot of one example embodiment of the viewer, in this case a Sudoku puzzle where symbols are moved to blank squares and acceptable moves are highlighted in green and unacceptable moves in red, and remaining elements to be placed are shown on the right of the puzzle.

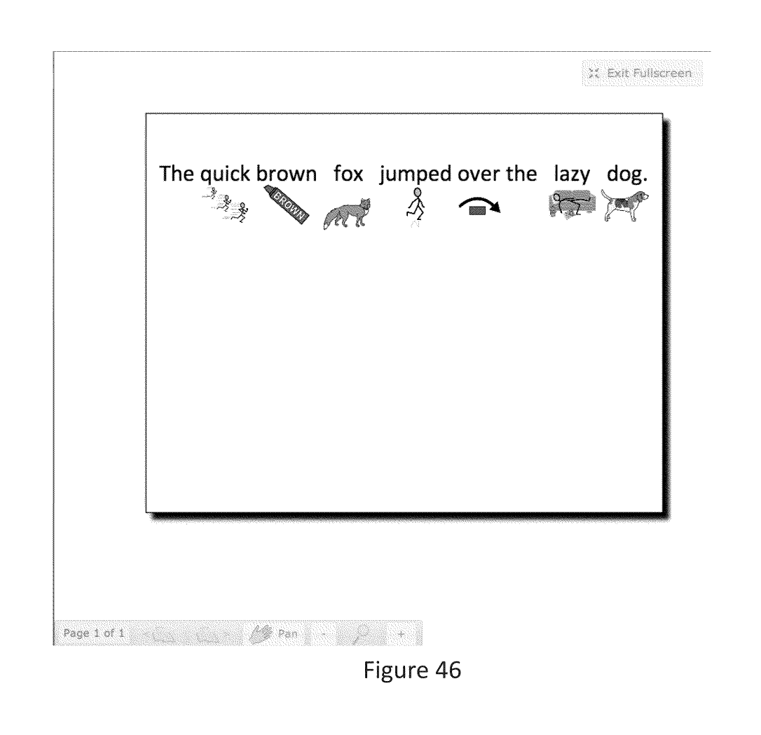

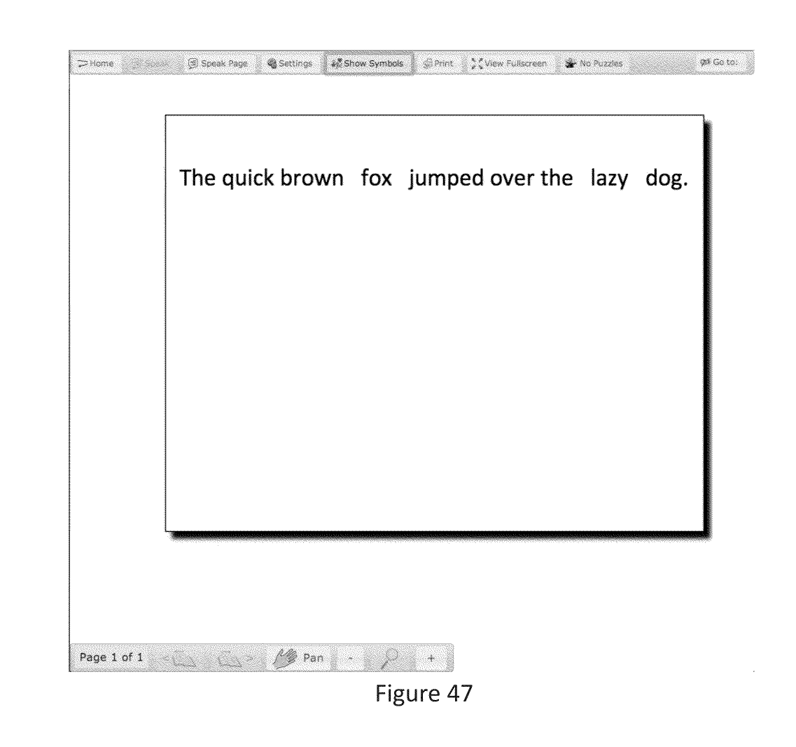

FIG. 46 shows a screen shot of one example embodiment of the viewer in the full-screen mode with a sentence showing completed symbol linking, in this case the sentence “the quick brown fox jumped over the lazy dog”. FIG. 47 shows an example screen shot of an example embodiment of the viewer after the Hide Symbols button was clicked for the sentence shown in FIG. 46, causing the symbols beneath the text to be hidden. Pressing the Show Symbols button that takes the place of Hide Symbols after it is pressed restores the symbols visibility.

Hardware Configuration

FIG. 31 shows an example high level architecture diagram by which web browsers 301a-301c running on computer devices communicate with the platform via the Internet, or another communication network.

Typically, the platform logic would be hosted as a cloud solution by a cloud vendor, on one or more Web Servers 302. The application logic would access files, such as idocs, images, and pre-computed audio from a binary file storage service 303 and data records, such as content and customer information, from a database 304. Both are accessed via the local network, which may be an Ethernet network, for example.

While typically it would be desirable that devices, such as personal computers or tablets, use commercially available web browsers (e.g., Internet Explorer or Firefox) to utilize the platform of the invention, as an alternative, custom programs or “apps” could be loaded within the consumer device to provide enhanced functionality, where desired.

The platform of the example embodiments may be implemented in a manner that one skilled in the art of computer programming would understand. Various programming tools, for example including one or more of .NET, node.js, Java, php, Ruby, variants of C, Javascript and HTML, etc. could be utilized as desired in implementing the platform logic. Commercially available self-hosted web servers or cloud solutions running across Windows Azure, Amazon Web Services, Google or Rackspace could be utilized in hosting the platform.

As will be appreciated by one of skill in the art, the example embodiments described herein, among others, may be actualized as, or may generally utilize, a method, system, computer program product, or a combination of the foregoing. Accordingly, any of the embodiments may take the form of an entirely hardware embodiment, an entirely software embodiment (including firmware, resident software, microcode, etc.) for execution on hardware, or an embodiment combining software and hardware aspects that may generally be referred to as a “system.” Generally, the “system” will comprise a server with storage capability such as one or more databases that interact with a plurality of remote devices via a communication network such as the Internet, an intranet, or another communication network such as a cellular network, for example. Such networks may utilize Ethernet, WiFi. Bluetooth, POTS, cellular, combinations thereof, or other network hardware. The remote devices include any of a plurality of computing devices, such as smart phones, phablets, tablets, or personal computers, for example. The remote devices will execute software, in the example embodiments typically generally available web browsers, typically without specialized plugins (although downloadable applications and/or plugins could be utilized for some embodiments) to perform the functions described herein.

Furthermore, any of the embodiments may take the form of a computer program product on a computer-usable storage medium having computer-usable program code embodied in the medium, in particular the functions executing on the server system which may include one or more computer servers and one or more databases.

Any suitable computer usable (computer readable) medium may be utilized for storing the software to be executed for implementing the method. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), cloud storage (remote storage, perhaps as a service), or other tangible optical or magnetic storage device; or transmission media such as those supporting the Internet or an intranet.

Computer program code for carrying out operations of the example embodiments (e.g., for the aps or server software) may be written by conventional means using any computer language, including but not limited to, an interpreted or event driven language such as BASIC, Lisp, VBA, or VBScript, or a GUI embodiment such as visual basic, a compiled programming language such as FORTRAN, COBOL, or Pascal, an object oriented, scripted or unscripted programming language such as Java, JavaScript, Perl, Smalltalk, C++, Object Pascal, or the like, artificial intelligence languages such as Prolog, a real-time embedded language such as Ada, or even more direct or simplified programming using ladder logic, an Assembler language, or directly programming using an appropriate machine language. Web-based languages such as HTML (in particular HTML 5) or any of its many variants may be utilized. Graphical objects may be stored using any graphical storage or compression format, such as bitmap, vector, metafile, scene, animation, multimedia, hypertext and hypermedia, VRML, and other formats could be used. Audio storage could utilize any of many different types of audio and video files, such as WAV, AVI, MPEG, MP3, MP4, WMA, FLAG, MOV, among others. Editing tools for any of these languages and/or formats can be used to create the software.

The computer program data and instructions of the software and/or scripts may be provided to a remote computing device (e.g., a smartphone, tablet, phablet, PC or other device) which includes one or more programmable processors or controllers, or other programmable data processing apparatus, which executes the instructions via the processor of the computer or other programmable data processing apparatus for implementing the functions/acts specified in this document. It should also be noted that, in some alternative implementations, the functions may occur out of the order noted herein. In particular, the disclosed embodiments will utilize installed operating systems running commercially available web browsers for providing graphical user interfaces for interacting with the users using the remote devices.

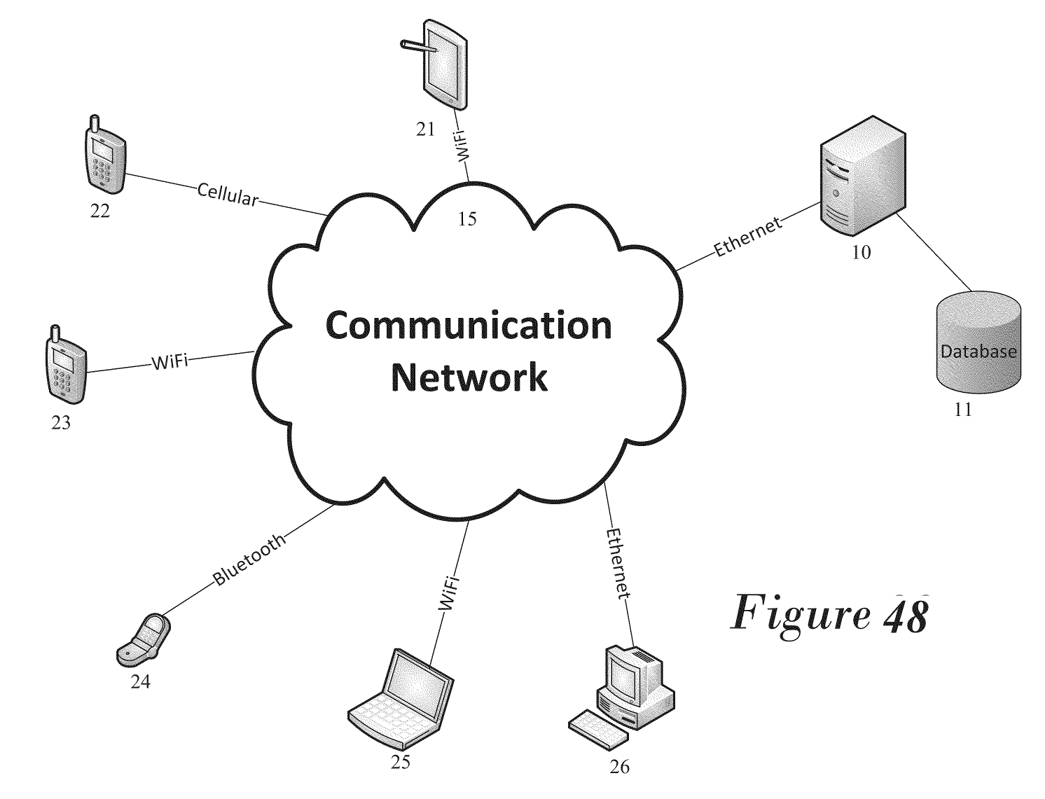

FIG. 48 shows an example of various hardware networked together that could be used for implementing the system described herein. A server 10 is connected to a database 11 for storing the various software applications for generating the data for transmittal to the various external devices 21-26 for implementation using installed web browsers. The server may be an a web server located in the “cloud”, and it will likely be accessible to the remote computing devices via a communication network 15, which may include the Internet, cellular networks, WiFi networks, and Bluetooth networks, among others. The external devices include, among others, tablets 21, smartphones 22, 23, cellphones 24, laptops 25, and personal computers 26, among others, any of which may connect to the server 10 via the communication network 15 (e.g., the Internet) via various means described herein.

Example Applications

Note that the specific properties and their mode of editing might be changed in certain embodiments of the invention, utilizing similar principles.

As discussed above, FIG. 1 is a flow chart showing example top-level steps taken by the content creator using the example platform. Content creators access the editor via a secured website 101. Content creators begin their content creation either from a blank document 103 or a template document 104 that was previously created using the editor, making this selection from an interface that lists available templates. The user is then able to use all of the functions of the editor to create the interactive, symbolated document 105, saving to the cloud as often as desired 106. When the document is ready, the content creator is able to publish the document 107 which makes the document available for reading and interaction using the viewer accessed from the website.

FIG. 39 shows an example embodiment that lists documents as lessons for the content consumer, visible once the document has been made available to users by publishing. Hence, specific lessons can be prepared for targeted users to access.

FIG. 30 shows an example top-level process that content consumers follow when viewing and interacting with the document. The published content is accessed by the consumer using a web browser, and can be made accessible directly without requiring a login, or if secured, the content consumer must first login via a secure website. The consumer is then presented with one or more forms of navigation (including but not limited to navigating by category or by search) and is able to click to choose and open a document in the viewer. Once the document is loaded in the viewer, the consumer may perform multiple tasks, that from a high level are to navigate the pages and page content of the document, print out a hardcopy of the document, or interact with the document contents and presentation.

Note that the sequence of the above steps in the processes of creating content or viewing content using the platform might be changed to support different scenarios without straying from the overall concept of the example embodiments. Both content consumers and content creators could utilize the most recent versions of a web browser available on a computer, device or mobile device in communicating with the platform. Hence, the system in at least some embodiments need not install or update software on the user computer, rather using common browsing applications already installed and kept up-to-date on most user computers.

One Example Embodiment discussed in this section utilizes the infrastructure shown in FIG. 32 to implement the high-level processes for the editor FIG. 1 and the viewer FIG. 30 supporting the platform of the invention.

Below is described the functions and screens of general example embodiments from an operational perspective, for both the content creation and content consumption scenarios.

Editor: FIG. 2 is a chart that provides a top-level reference to examples of the functions of the editor that will be discussed in the sections that follow. An example screenshot of the editor is shown in FIG. 4. There are four tool areas in the example embodiment: a main toolbar 141, a property inspector 142, a navigation toolbar 143 and a shapes toolbar 144. The design surface 145 (variously referred to as a stage, whiteboard or page box) is where content is positioned and edited, and can be viewed. These features are available to the content creator when creating and editing a document, which correspond to steps 105 and 106 in FIG. 1.

Shape Editing: Fundamental to the creation of the documents using this process is the placement and editing of shapes. FIG. 22 shows an example document loaded in the editor illustrating all shapes available in the example embodiment, along with the toolbar used to select a shape and place it on the page. Shapes can be deleted by selecting the shape and using the delete or backspace key or by clicking the red X button in the main toolbar 141 shown in FIG. 4. Selected shapes can be copied and pasted using the Copy and Paste buttons respectively, shown in main toolbar.

The following are used to identify the shapes in the shapes toolbar: (1) Artistic Text shape—used for creating a symbolated line of text; (2) Paragraph Text shape—used for creating multiline text that automatically wraps the text within the width of the shape; (3) Rectangle shape—used to create a rectangle or a square; (4) Circle shape—used to create a circle; (5) Oval shape—used to create an oval; (6) Line shape—used to create a line; (7) Single Arrowhead Line—used to create a line with an arrowhead on one side; (8) Double Arrowhead Line—used to create a line with arrowheads on both sides; (9) Equilateral triangle shape—used to create an equilateral triangle; (10) Symbol shape—used to create a symbol that is not associated with text; (11) Crossword shape—used to create a crossword; (12) Sudoku shape—used to create a Sudoku puzzle; and (13) Graphic shape—used to create a bitmap graphic from a bitmap file on content creator's system.

While, for example, most shapes are added by clicking on the shape in the shapes toolbar, and then clicking on the desired location in the page, the Graphic shape can also be added when the content creator drags and image file from the computer desktop and drops it on the page.

FIG. 28 shows a flowchart of an example process by which a bitmap image can be added to a document in the example embodiment of the editor. A content creator can be used to drag an image from the desktop and drop it on the editor design surface, or use the graphic tool and then choose the file. Irrespective of how the image file is selected, once selected, the file is automatically uploaded to the storage web service and linked into the idoc file via a URL.

Property Inspector: In the example embodiments, when one or more shapes are selected in the editor, the properties specific to the selection are displayed in a dialog on the right side of editor. This is referred to as the property inspector. Editing any property in the property inspector causes the selected shape to be updated and displayed with the new value. The property inspector is also used for page setup, table of contents configuration and the configuration of text to speech, depending on the editor mode and what is actively selected. This section will focus on shape properties, and subsequent sections will discuss page setup, table of contents and text to speech configuration.

FIG. 4 shows as an example an Artistic Text line selected in the editor 145; to the right of it is the property inspector 142 for that shape (it starts with the “Size: 36 pt” property).

FIGS. 23A-23I show various example screen shots of property inspectors for the named shapes in the example embodiment of the editor. All shapes have the properties shown in FIG. 23A, when selected in the editor. Text lines (Artistic Text and Paragraph Text) have the properties shown in FIG. 23B. All vector shape primitives (those other than text or images) have the properties shown in FIG. 23C. FIGS. 23D-23I show the properties in addition to FIG. 23C that each shape named in the figure contains, such that what is displayed in the property inspector is a combination of the two.

A list of the properties shown and their meaning include: (1) X Coordinate—X coordinate of the shape in pixels; (2) Y Coordinate—Y coordinate of the shape in pixels; (3) Width—pixel width of the shape; (4) Height—pixel height of the shape; (5) Scale X—percentage of horizontal scaling; (6) Scale Y—percentage of vertical scaling; (7) Rotation—rotation in degrees; (8) Is Interactive—when checked, indicates shape is interactive in the viewer; (9) Type—the type of interactivity supported by the shape; (10) Value—the value of the shape when it is interactive; (11) URL—the website URL to navigate to when the shape is clicked in the viewer; (12) Open In—controls how the URL is navigated to when shape is clicked in the viewer: in the current browser window or in a new window; (13) Size—point size of the font used for text; (14) Fonts—the font face used for text; (15) Style—the text style (bold or italic); (16) Align—the horizontal alignment of text; (17) Color or Fill Color—the text color or the color filling a shape like a rectangle; (18) Transparent—when checked indicates that there is no fill color on the shape; (19) Stroke—the color of the shape outline; (20) Stroke Width—the width in points of the shape outline; (21) Length—the length in pixels of a line shape; (22) Line Join—the style used on corners of a shape, where two line segments meet (miter, round or bevel); (23) Line Cap—the style used at the ends of a line (round, square or butt); (24) Radius—the radius of the equilateral triangle in pixels; (25) Radius X—the width in pixels of the ellipse; (26) Radius Y—the height in pixels of the ellipse; (27) Line Spacing—the percentage amount of spacing between text lines for a Paragraph text box, relative to the font height; and (28) Multiline—when checked the text shape is treated as a Paragraph text shape, otherwise it is treated as an Artistic text shape.

There is at least one additional attribute used by Artistic text and Paragraph text shapes that is not visible via the property inspector. The textual content of the text shape can contain variables that are automatically replaced by computed values when the text shape is not being edited. The page number is represented by the character sequence ˜% pn %˜ and will be replaced with the integer ordinal of the current page whenever the text shape is not being edited.

In addition to setting these properties, the stacking (or layering order or Z-Order) of shapes is controlled by right clicking on a shape and selecting one of the options to move the shape above or below other shapes, as shown by the example of FIG. 23K.

FIG. 23J shows an example of the resulting property inspector when selecting multiple shapes in the example embodiment of the editor. All the properties common across all shapes in the selection are coalesced and displayed with a value (if the properties also share that common value) or a blank or default value if that value is not common for that property across the shapes. In FIG. 23J, none of the properties are common so they are all shown blank or have the value “0”. Properties that are not common to all shapes in the selection are not displayed. A new group of properties appears in the property inspector when more than one shape is selected.

As FIG. 23J shows, these are options for the horizontal and vertical alignment, and horizontal and vertical distribution of shapes relative to each other. These properties and their meaning are, for example: (1) Horizontal Align—the options in order of display are Align Left sides, Align Centers, Alight Right sides; (2) Vertical Align—the options in order of display are Align Top sides, Align Centers, Align Bottom sides of the selected shapes; (3) Distribute Horizontally—Makes the horizontal space between the selected shapes equidistant; and (4) Distribute Vertically—Makes the vertical space between the selected shapes equidistant

When multiple shapes are selected, as in the example embodiment, right clicking on any one of the selected shapes displays a menu enabling the content creator to group or ungroup the shapes. The result of grouping is that the multiple selected shapes are treated as an atomic shape. The result of un-grouping is to break apart the group into the constituent shapes.

Shape Scaling and Positioning by Dragging: In addition to using the property inspector to specify the X,Y coordinates, the dimensions (width, height or radius) or rotation, the content creator can affect these by selecting a shape on the page surface and then clicking and dragging on one of a few specific regions referred to as handles. FIG. 37 shows all the handles visible around a graphic shape. The circle handle above the image is used to rotate the shape by clicking and dragging left or right to rotate in that direction. By clicking on any of the square handles in the middle of the border, the shape will be scaled up or down in just that dimension. For example, clicking and dragging the right-border square to the left will make the image less wide horizontally, while dragging to the right will make the image wider. Similarly, clicking on the bottom square and then dragging will adjust the vertical height of the image, making it shorter by dragging up or taller by dragging the handle down. Clicking on any of the circular handles on the corners of the shape border allow free scaling in both the X and Y direction. By clicking in the middle of the shape and not on any of the handles, the user can drag to reposition the shape of the page, transforming its X,Y coordinates.

Symbolated Editing: Symbolated editing is the process of typing text and having the system automatically suggest appropriate symbols for placement near the selected text, enabling the user to choose the most appropriate symbol and then placing the symbol on the document. In the example embodiment, symbols are placed centered beneath the text, but could alternatively be placed with a different alignment relative to the text. Hence, the example system increases user productivity by the automatic suggestion of symbols while the user is typing the text.

FIG. 3A is a flow chart described above showing an example of the process of adding symbols to a line of text in the example embodiment of the editor. Provided is a mechanism for selecting free-floating lines of text within a document 130, entering a mode to edit the text contents of the line 131, selecting a particular word or phrase within the text line 132, automatically suggesting symbols to the content creator 133 that relate to the selected text, enabling the content creator to select the most appropriate symbol 134 and placing the selected symbol in the document 135 in the proper position. After placement of the symbol, the symbol can be replaced with another symbol 136 or have its position, rotation size and spoken text properties modified 137.

FIG. 3B shows a screen shot of the example embodiment of a user selecting text in a text line to display the automatically suggested list of symbols for the selected word “fox,” while FIG. 3C shows the result symbol placement after the user has selected the first option in the list. When symbolating text in this way, the example embodiment of the editor shows a red * for each space between words in the text, in order to enable the content creator to visualize the quantity of space characters, so that the content creator may consistently apply the same number of spaces before and after a word. This is of particular importance on shorter words, where the symbol might be wider than the word, requiring some extra spacing around the word so that the symbol does not overlap the space below the word that precedes or follows the text it is associated with.

FIG. 3D shows an example of the advanced symbol picker that is displayed when the user chooses the “search more . . . ” option found at the end of the list of suggestions in FIG. 3B. In the example embodiment, this enables the user to page through the suggested symbols, such as by showing 12 symbols at a time, and when the user selects one of the symbols, the chosen symbol is placed below the text, similar to that shown in FIG. 3C.

FIG. 3E shows a screenshot of an example embodiment of the screen used to bulk replace all symbols in the document associated with a particular word with another replacement symbol. In this example, the document contains multiple symbols. Selecting “fox” enables the content creator to search for and select any other symbol, and then the system automatically replaces all instances of the symbols in the document by the user clicking the Replace button.

Symbol to Text Association: All modifications made to the content or formatting of the text cause the associated symbols to adjust their position automatically to stay synchronized with the position of the text. The position of the symbols is updated according to the changes calculated from the metrics of the text line. The following paragraph discusses the particular scenarios supported by the example embodiments:

(1) When transforming the text line by adjusting its X,Y coordinates relative to the page, all symbols associated with that line move with it as a single unit; (2) When editing the text line, character insertions or deletions that cause a text range associated with a symbol to shift horizontally, also cause the associated symbol to shift horizontally, according to the configured alignment of the text box, so that the symbol continues to appear beneath the text range; (3) When modifying the font face, font style, font size or the alignment of text characters within the single line text box, the symbols position is adjusted to retain the alignment with the associated text range.

Symbol Manipulation: Once a symbol is added, it can be selected like any other shape on the document page and thereby be manipulated. Its dimensions can be scaled in any direction using the anchors on the edges and corners of the symbol's bounding box, or by using the transform editor in the property inspector. When transformed in this fashion, the symbol continues to maintain its association with the text and responds to text edits and format changes.

A symbol associated with text can have its X and Y coordinates transformed by the content creator (either via a drag and drop operation or by editing the actual X,Y coordinates in a property inspector dialog). When the symbol is transformed in this way, text content modifications or format changes take into consideration this new position. This enables users to adjust the position of the symbol relative to the text, for example, to better horizontally center the symbol beneath the text or to move introduce more vertical whitespace between the symbol and the text.

Symbols can be scaled in the horizontal and vertical directions and still retain their association with, and relative position to, the text. Symbols can be rotated by clicking on the rotation anchor and dragging around the symbol, or by adjusting the rotation in the transform editor of the inspector. When transformed in this fashion, the symbol continues to maintain its association with the text and continues to respond to text edits and format changes.

Symbol Lookup and Suggestion: in populating the list of suggested symbols for display to the content creator, the database can be queried. The following discuss the approach taken and scenarios supported by the example embodiment: Querying a database of symbols using the value of the selected text as the search keyword and both linguistic stemming and synonyms during the search generates the list of suggested symbols. This enables suggestion of words and symbols beyond a direct match on the keywords represented by the selected text. If the desired symbol does not appear in the short list of symbol suggestions, the user is able to select “search more” and perform an advanced symbol search using the advanced symbol picker, as shown in FIG. 3D. If the user does not see the desired symbol, the user is able to change the keyword being used for the search and launch a new symbol search within the advanced symbol picker based on that keyword instead.

Symbols and Text-to-Speech: When a content consumer clicks a symbol in the viewer, the symbol has a text value that can be spoken. Symbols are automatically configured to speak aloud their associated text, which by default is the name of the symbol as it appears in the database. This associated text is configured and can be replaced with alternative spoken text via the property inspector when a symbol is selected in the editor.

Speech Editing: The textual content of a document can be spoken using text to speech. Both the editor and the viewer in the example embodiment support speaking out loud an individual symbol, a line of text or speaking an entire page following a predefined reading order. The editor is used for specifying this reading order, as well as configuring the speech, including any alternative pronunciations.

FIG. 20 shows a screen shot of the example embodiment of the editor in speech ordering mode. This mode is entered by clicking the Enter Speech Ordering button in the main toolbar (as shown in FIG. 4). In the speech ordering mode shown in FIG. 20, holding the CTRL key while clicking on an Artistic or Paragraph text shape appends it to the reading order when the page is spoken using text-to-speech. Holding the CTRL and ALT keys while clicking on a text removes the text from the reading order. The reading order is indicated with a numeric tooltip 201 floating near the top left corner of the text box. When selecting a single textbox, the property inspector 202 displays settings specific to text to speech. There is a checkbox for “Include in page reading order” in the properly inspector 202 to include the text line when reading the page using text-to-speech, “Reading Order” which controls the order in which lines are spoken. “Phonetic Content” is text that, by default, is set to the same text value as the content of the text line, but can be overridden to provide the text to speech engine (in a manner specific to the engine used) with additional hints on pronunciation, insert particular inflections, or to adjust the duration of pauses.

FIG. 21 shows a screen shot of the example embodiment of the editor in speech ordering mode, showing how a symbol shape can have alternative spoken text.

Puzzle Editing: The editor is also used to create interactive puzzles that are interacted with using the viewer. Any shape on the document page can be selected and made interactive using the property inspector of the editor, and the example embodiment supports many forms of puzzle interaction. These canonical interactions include, for example: “matching”, “counting”, “circle answer”, “circle multiple” and “text entry”. At a high level this process involves configuring one or more shapes as puzzle pieces, and for some puzzles configuring a shape as puzzle that is the target of the puzzle pieces.

Structure Document: The example embodiment of the editor has multiple functions used for creating and modifying the structure of the document. In short, a content creator can: (1) insert, delete and re-order pages; (2) define a table of contents; (3) define virtual pages in the table of contents; (4) create and apply page templates; and (5) adjust page setup. Paragraphs that follow describe some of these functions as they appear in an example embodiment.

Page Ordering: FIG. 25 shows a screen shot of the example embodiment of the navigation toolbar in the editor. When the Reorder button is pressed on the navigation toolbar, the Reorder Pages dialog is displayed. FIG. 24A shows a screenshot of the example embodiment of the reorder page dialog in the editor, which serves two functions: One is to re-arrange pages within the document, and the other is to manage virtual pages. All of the pages in the document are listed under the Page order section. The content creator can select any one page in the list and press the Move Up button to move the page towards the beginning of the document or press the Moved Down button to move the page toward the end.

Virtual Pages: FIGS. 24A-24C collectively show the process of adding a virtual page. A virtual page is an entry in the document table of contents that does not represent a physical page in the document. It enables a content creator using the example embodiment of the editor to provide hypertext links to external documents within the table of contents. In the example shown in FIG. 24B and FIG. 24C, a virtual page is added titled Tool Store, subtitled Home Depot, which when clicked will go to the Home Depot website. Content consumers using the example embodiment of the viewer against the same document see a table of contents listing like that shown in FIG. 24D. Once a virtual page has been added in this way, a content creator can use the Reorder Pages dialog shown in FIG. 24A to adjust the position of the virtual page within the table of contents.

Table of Contents: FIGS. 26A-26B show screen shots of the example embodiment of the inspector settings used to configure document metadata in the editor displayed when a page is selected. FIG. 26A shows how the documents title, subtitle and icon are set. FIG. 26B is set for every page that should have an entry in the table of contents.

Page Templates: Page templates (sometimes referred to as “master pages”) are a special type of page that can be used to share common page elements across multiple pages, they can contain any of the shapes that a regular page can contain. Common examples of this are logos or headers that should be repeated at the top of every page, and/or copyright information that should repeat at the bottom of every page.

The example embodiments allow a content creator to create one or more page templates within a single document. Each regular page in the document can be associated with zero or one page template. If desired, a regular page can be promoted to become a page template, so that its content can be easily shared across multiple regular pages. The content added to the regular page from a page template is not editable when editing the regular page. However, any changes made while editing a page template will be reflected by all regular pages to which the page template is applied. The process of associating a page template with a regular page is referred to as applying the page template. The process of breaking that association is referred to as unapplying the page template.

FIG. 33a shows a regular page as created in the example embodiment of the editor. FIG. 33b shows the page template that was applied to the regular page in 33a, specifically in this example a footer was created in the page template that had the date and copyright information.

The process for creating a page template in the example embodiment begins with the content creator clicking on the Edit Master Page button located in the main toolbar 141 in FIG. 4 to enter the page template editing mode. There is always a default master page if one is not applied to any of the regular pages in the document. This mode appears the same as shown in FIG. 4, except the Edit Master Page button is highlighted to show the new mode. The shape toolbar 144 and property inspector 142 work as described previously for regular pages. However, the navigation toolbar 143 takes on a new context—instead of navigating between regular pages, the next page and previous page buttons are used to navigate between the template pages available in the document. The + Before, + After, and Delete buttons add a new master page before or after the current template page, or delete the template page respectively. The Reorder button is disabled and not used within the page template editing mode. From this mode, the content creator is able to add any shapes to page surface that they might have added to a regular page.

The last step the content creator follows is to name the template page. The content creator clicks on an empty area of the page to select the page and display the property inspector for the page as shown in FIG. 34. By setting the property labeled “Title” the content creator can give each master page a user friendly name. In the situation that no name is provided, the system automatically assigns a unique name to the page template. When finished editing the page template, the user clicks the Edit Master Page button again to exit the page template editing mode.

When the content creator desires to apply a page template to a regular page, the content creator will right click on a page and from the menu that appears in FIG. 35a, select Apply Master. FIG. 35b shows the dialog that appears. The content creator can choose a page from the list and click OK to apply the page template. To remove an applied page template, the content creator right clicks on a page, and selects the Un-apply Master Page options as illustrated by FIG. 35a.

Page Setup: In either regular page editing mode or page template editing mode, the user is able to set the page orientation, and control the visibility of gridlines and margins via the property inspector. FIG. 36 shows the property inspector 3 that appears when a page is selected in the example embodiment of the editor. It shows the page configured for a landscape orientation, displaying both gridlines 1 and margin 2.

The following are the properties available to a page: (1) Orientation: the page orientation can be portrait (tall) or landscape (wide). Changing this immediately updates orientation of the page displayed; (2) Gridlines: when checked, light gray gridlines appear on the page to assist with shape layout, otherwise these are hidden; and (3) Margin: when checked, a fuchsia stroked rectangle is displayed on the page to indicate the printable margin, otherwise this rectangle is hidden.

Navigate Document: The content creator is able to use features of the editor to navigate within and across document pages. FIG. 25 shows a screen shot of the navigation toolbar within the example embodiment of the editor. The current page and total number of pages in the document is displayed. With regards to navigating between pages of a multiple page document, the < button is used to go to the previous page and the > button is used to go to the next page. When the content creator is viewing the beginning of the document, the < button is disabled. When the content creator is viewing the last page in the document, the > button is disabled. The content creator can zoom in on a region of page by repeatedly pressing the + button, or zoom out by repeatedly pressing the − button. To move around a zoomed in document, the content creator can use the Pan toggle button, then click and drag on the screen to pan the viewable content around (without resorting to scrollbars).

Spell Check: The example embodiment of the editor provides automatic spell checking of textual content. Whenever an Artistic text shape or Paragraph text shape is being edited, any misspelled words are underlined in orange. If the content creator right clicks on such an underlined text, a context menu appears with the suggested spelling alternatives as shown by FIG. 38. The content creator can click on one of the alternatives to replace the misspelled word with the suggested alternative.

Preview Document: At any point during document editing in the example embodiment, the content creator can click the Preview button in the main toolbar shown in FIG. 4. This will load the document in a new browser window in the viewer, without requiring the content creator to first save the document.

Print Document: The content creator can print out a hardcopy of the document currently being edited in the example embodiment of the editor by clicking on the Print button in the main toolbar 141 shown in FIG. 4. The application will render, in an area hidden from view, a hi-resolution bitmap of each page in the document and create an HTML page that holds all the images, each attributed with CSS print media styles to ensure that each bitmap gets printed on its own physical page by the printer, and then use the browser's built-in print functionality to print the page of bitmaps.

Annotations: Content creators often collaborate on documents. To support this, the example embodiment of the editor provides them with the ability to add annotations to any document open in the editor.

FIG. 27 shows a screen shot of the example embodiment of the editor showing it in the annotation mode. Annotations are added to the document using the annotation tool (the bottom-most tool in the shapes toolbar 186) and then edited just like a text box. Once added, annotations appear in a dialog box 187 shown on the right. By clicking on an entry in that dialog box 187, the user can quickly navigate to the page containing that annotation. In order to access annotation features and view annotations in this way, the user should enter the Annotation mode, which is entered by clicking on the Annotate button in the main toolbar 141 shown in FIG. 4.

Undo and Redo: During the course of editing, the content creator may click the undo button in the main toolbar to undo the latest change to the document. The content creator can click the undo button multiple times to revert actions performed in reverse chronological order. The content creator can click the Redo button to undo the undo by re-applying the change that was undone. Both the Undo and Redo buttons are available in the main toolbar shown in FIG. 4.

Open Document: Before being able to edit any document, the user should first open the editor and indicate which document to load, both of which are indicated by the URL entered into the web browser.

FIG. 5 is a flow chart showing an example process of opening an idoc in the example embodiments of the editor. Save Document: At any point during editing, the content creator can click the Save button to persist the document to the platform. The Save button is located in the main toolbar 141 shown in FIG. 4.

FIG. 6 is a flow chart showing an example process of saving the content created in the example embodiment of the editor. Within the save process, any items only used for display during editing are hidden. Then the document is serialized to a Javascript Object Notation (JSON) string representing the idoc format. That string is sent using the XmlHttpRequest2 object, available in the web browser, to the platform storage web service. There it is persisted as a file with the idoc exention using the Windows Azure Blob Storage service. A confirmation of the data received is created by computing a hash of the data received and returning it in the response message to the browser, should the application choose to verify the integrity of the document that was saved.

Viewer: The viewer is used by content consumers to view and interact with documents originally created using the editor. FIG. 30 shows the example document viewing process followed using the example embodiment of the viewer. The detailed functionality for navigating the document, printing and interacting with the document, once the document has been loaded into the viewer by the content consumers web browser, is described below.

Open Document: The content consumer navigates to, and opens, a document by means of following a specially formatted URL in the web browser. The process followed to open a document is the same as that followed by the editor as shown by the flowchart in FIG. 5, except some steps are skipped because the file is not being opened for editing and therefore does not have to be locked to protect against multiple concurrent operations to open it.

The process begins with the viewer using the web browsers XmlHttpRequest object to make a request to the Storage Web Service. The storage web services parses retrieves the request idoc from Windows Azure Storage, then returns the content of the file in the response to web browser request. The viewer receives the response, loads the JSON representing the idoc into a variable and then loads images, fonts and other resources and then displays the loaded document in the viewer.

Navigate Document: Once the document is displayed in the viewer, the content consumer can navigate the document in various ways.

FIG. 40 shows a screen shot of the navigation toolbar within the example embodiment of the viewer. The current page and total number of pages in the document is displayed. With regards to navigating between pages of a multiple page document, the < button is used to go to the previous page and the > button is used to go to the next page. When the content consumer is viewing the beginning of the document, < button is disabled. When the content consumer is viewing the last page in the document, the > button is disabled. The content consumer can zoom in on a region of page by repeatedly pressing the + button or zoom out by repeatedly pressing the − button. To move around a zoomed in document, the content creator can use the Pan toggle button, then click and drag on the screen to pan the viewable content around (without resorting to scrollbars).

In addition to navigating page-by-page, the content consumer is table to navigate using the table of contents. FIG. 26C shows a screen shot of the example embodiment of the viewer having a document loaded and displaying its table of contents. The content consumer is able to display the table of contents by clicking on the Go To button located in the on the far right of the viewer's main toolbar at the top of the screen. The content consumer can click on any entry within the table of contents list to navigate to that page in the document, or to navigate to URL that is the target of that virtual page.

Print Document: The content consumer can print out a hardcopy of the document currently being viewed in the example embodiment of the viewer by clicking on the Print button 6 in the main toolbar at the top of the screen shown in FIG. 41. The application will render, in an area hidden from view, a hi-resolution bitmap of each page in the document and create an HTML page that holds all the images, each attributed with CSS print media styles to ensure that each bitmap gets printed on its own physical page by the printer, and then use the browser's built-in print functionality to print the page of bitmaps.

Document Interaction: A document loaded in the viewer supports multiple forms of interaction, as provided by the example process shown in FIG. 30. At a high level, these interactions relate to speech, puzzle solving, and view configurations. The follow paragraphs discuss each of these in turn as they are supported by the example embodiment of the viewer.

Speech: Document content can be spoken aloud using text to speech as described herein. Within a document, a single selected line of text can be spoken, an entire page can be read aloud following a predefined reading order, and any symbol can have its name spoken.

FIG. 41 shows a screen shot of an example document loaded in the example embodiment of the viewer. The main toolbar at the top of the screen contains the buttons for Speak and Speak Page. To have a particular line of text spoken, the content consumer will select the line of text in the viewer and then click the Speak button. FIG. 42 shows a progression 1-4 across time as each word is spoken it is highlighted with a distinctive highlight color.

To have an entire page read following the preconfigured reading order (as defined by the content creator when using the example embodiment of the editor), the content consumer will click the Speak Page button shown in FIG. 41. The progression that results is exemplified by FIG. 43, where each of the three lines of text are read, first word-by-word, and then the next line in the reading order is read. The content consumer does not have to select any lines to speak in this case, as the page content is automatically read in-order. Furthermore, symbols present on the page can speak their phonetic content when the content consumer clicks on the symbol.

The highlight color and reading speed of spoken text are configurable. The content consumer can click on the Settings button in the main toolbar shown at the top of the page in FIG. 41. This will display the Settings dialog shown in FIG. 44. The highlight color can be set by entering a specific RGB value, or by clicking on a color in the palette. The reading speed is set by entering a value in the reading speed box, where in this example, 50 is the slowest and 200 is the fastest speed, and where 180 is the typical speed of natural sounding speech. Clicking OK applies the settings for the next use of an speech operation.

Puzzle Solving: The viewer is used by the content consumer to solve interactive puzzles defined within the document. The example embodiment of the viewer supports many forms of puzzle interaction. These canonical interactions include “matching”, “counting”, “circle answer”, “circle multiple” and “text entry”. As described above, FIGS. 8A-8E shows examples of screen shots of one form of a “matching” interactive puzzle being manipulated by a user of the example embodiment of the viewer. FIG. 45 shows an example of putting the puzzle capabilities in the context of real-world document loaded in the example embodiment of the viewer, in this case a Sudoku puzzle. In the upper left view, the content consumer has selected the symbol of the puppy and dragged it into one of the correct squares. In the upper right view, the content consumer has dragged the puppy symbol over an incorrect square. In the lower center view, the content consumer has dropped the puppy in one of the correct squares.

Whenever a page has at least one puzzle on it, the puzzle indicator, shown inactive in FIG. 41, instead lights up green and reads “Page has Puzzles”. An example of this is shown by FIG. 45 in the menu at the top of the screens.

View Configuration: The content consumer has a few options to control how the example embodiment of the viewer displays. FIG. 41 shows an example of the View Fullscreen button in the main toolbar at the top of the screen; pressing this button, the view can be switched to enter a full screen mode, as shown in FIG. 46 where the main toolbar is hidden and replaced with a transparent Exit Fullscreen button at the upper right corner. The navigation toolbar at the lower screen remains, but is made transparent.

FIG. 32 shows a detailed example architectural diagram of the example embodiment of the solution. The client side application is a form of rich web page referred to as a single page application that runs within a web browser on a desktop or mobile device. These features are described in more detail below.

Client Side Architecture: For the example embodiment, when loading the editor or viewer, numerous resources in the browser constitute the complete client side of the application, including HTML 5 Markup, Cascading Style Sheets (CSS), JavaScript modules, Web Fonts, and Images. HTML 5 Markup and CSS: HTML 5 markup controls the page structure and CSS style sheets the formatting of display. Within the viewer and the editor, the toolbars, buttons, menus, the design surface and the text editor are all constructed from HTML 5 elements with CSS 3 styles. The centerpiece of the editor and the viewer is the page design surface, which at its core is built on top of the HTML 5 canvas element.

The text editor displayed when editing Artistic text or Paragraph text is constructed from a DIV whose editable property has been set to true. The CSS applied to the DIV is configured to match the object model, the font face references a web font described in CSS, alignment, point size and style are also CSS properties set on the DIV. The DIV is positioned above the object representing the text on the canvas using CSS as well. When this DIV is displayed, the object representing the text on the canvas is hidden from view, giving the user the illusion of editing an item on the page surface.

The playback of text-to-speech audio is accomplished using the HTML 5 audio element, synchronized with the application of CSS styles to highlight the spoken text with a colored background. When playback begins, the text is displayed in the same text editor DIV used for editing text.

The indication of misspelt words is accomplished using CSS styles to repeat a patterned image and give the appearance of a wavy underline within the text editor DIV.

Printing is also supported by the use of the HTML 5 canvas, via a proprietary approach of rendering to the canvas in a higher resolution version of the design surface for each page than what is shown on the screen, and then using the canvas ability to export that to a bitmap and creating a temporary web page that includes all these bitmaps tagged with CSS so that they are formatted for printing one to a page.

The higher resolution image is achieved by repeating a particular process for each page of the document. It begins by drawing the same page content displayed on screen on the canvas that is now twice as wide and twice as tall as the originally, and then using the zooming functionality provided by the custom object model to magnify the content by 200%. In this way the page content completely fills the canvas. A bitmap is created from this canvas, and then added to a temporary web page being created in a new browser window, where the bitmap image is using an IMG tag that references its data using a data URL. The dimensions of the IMG tag are set so they are all halved from the original size. This effectively doubles the resolution and makes the output suitable for crisp printing on devices like color laser printers and inkjets. The particular scale factor is not important and can be increased to create higher resolution outputs as required by the output device.

JavaScript Modules: There are numerous JavaScript modules that range in function from providing an object model for the display and selection of shapes on the canvas, processing user mouse, keyboard and touch interactions, communicating with the platform web services, synchronizing text to speech audio with text highlighting and rendering the interactive document and rendering for printing.

Web Fonts: The client side application loads various web fonts whenever content requiring that font is displayed, to ensure the presentation fidelity of the document is preserved, even when the user does not have the required fonts installed on the device used. These fonts are downloaded from the website.

Speech Audio: When text to speech is activated, the client application will download audio files in the MP3 format by loading them into the HTML 5 audio object, and synchronize their playback with a timing document that is used to guide the highlighting of spoken text on the display.

Images: The viewer and the editor example embodiments make use of images, primarily in the PNG format, in numerous locations including icons on buttons and toolbars, graphic images in a document and symbols present in a document. These may be downloaded directly from the website or from Windows Azure Storage by means of an intermediary storage web service that is hosted by the website.

Server Side Architecture: The web site application logic is implemented using Microsoft ASP.NET to provide all web pages and web services required by the client application. The server side resources are hosted in Microsoft Windows Azure Websites. There are five primary web services included in the platform: storage, symbols, spelling, speech and proxy. All are implemented using the ASP.NET Web API.

Storage Web Service: a web service for accessing binary files from the file storage provide by Azure.

Symbols Web Service: a web service for searching for symbols by keyword or category against the database of symbols stored in a MySQL database, and constructing a URL for downloading the PNG bitmap representing that symbol using the storage web service.

Spelling Web Service: a service for spell check that takes as input an array of strings to check (usually this array contains all the words in the Artistic text or Paragraph text being edited). It returns an array of objects, one for each word, indicate true if correctly spelt or false if not. If the user right clicks on a misspelt word, this service is invoked to retrieve an array of suggested alternative spellings for that word. The dictionaries used by the spelling web service are hosted within the website.

Speech Web Service: A proxy service for dynamically generating text to speech audio and timings documents that invokes 3rd party text to speech web services for the generation of the audio file and timing documents.

Proxy Web Service: A proxy service for accessing documents thru the storage web service or the symbols web service. This service is always located with the web page content, and is used to enable the distribution of the storage and web services to separate web server hosts, while still retaining the appearance of a single origin request to the browser. Without this service, actions such as printing documents constructed of images or symbols retrieved from distributed storage or web services will fail because they violate the single origin policy enforced by the browser for such content displayed in a HTML 5 canvas.

Models, Views, Controllers: In addition to these services, there are views which generate the HTML 5 markup, the controllers, which contain the server side logic, and models which describe the data payload passed between application components.

Backend Architecture: In this embodiment symbolated documents in the idoc format are stored in Windows Azure Blob storage. This same storage is used to store the graphic files representing symbols and the images uploaded by users, as well as any pre-computed text to speech audio and timing files.

The primary database which contains all records pertaining to users, accounts, enumeration of documents, and descriptions of symbols are stored within a MySQL Database on Windows Azure that is provided by ClearDB.

Many other example embodiments can be provided through various combinations of the above described features. Although the embodiments described hereinabove use specific examples and alternatives, it will be understood by those skilled in the art that various additional alternatives may be used and equivalents may be substituted for elements and/or steps described herein, without necessarily deviating from the intended scope of the application. Modifications may be necessary to adapt the embodiments to a particular situation or to particular needs without departing from the intended scope of the application. It is intended that the application not be limited to the particular example implementations and example embodiments described herein, but that the claims be given their broadest reasonable interpretation to cover all novel and non-obvious embodiments, literal or equivalent, disclosed or not, covered thereby.

What is claimed is:

1. A method of creating a symbolated document using a server comprising one or more computers and databases for executing specialized software for implementing said method which comprises the steps of:
the server sending instructions over a computer network to a remote computing device to cause the remote computing device to provide a user interface process including the steps of:
accepting textual words from a user for display in the document,
automatically suggesting a plurality of symbols, each comprising a graphical picture, for each one of at least a subset of said words, one at a time,
for each one of said subset of words, accepting a selection of one of said suggested one or more symbols for associating with that respective one of the words,
displaying the symbolated document on the remote computer device showing the textual words with the associated symbols, and
sending document data representing the symbolated document displayed on the remote computing device to the server;
the server storing the document data; and
the server using the stored document data for interacting with one or more additional remote computing devices over the computer network for displaying the symbolated document on the additional remote computing devices.

2. The method of claim 1, wherein said user interface includes a step of automatically converting the textual words to speech, and wherein the displaying of the symbolated document on the additional remote computing devices includes providing the capability to convert the textual words to speech.

3. The method of claim 2, wherein said user interface includes accepting a user input for setting a speed of the speech.

4. The method of claim 1, wherein said user interface includes providing a user with one or more interactive puzzles for adding to the symbolated document.

5. The method of claim 1, wherein said user interface includes a global replace function for automatically replacing a plurality of a symbol that is associated with multiple instances of a particular word with another symbol for associating with that particular word.

6. The method of claim 1, wherein each one of said symbols is displayed near its respective associated word in the symbolated document.

7. The method of claim 6, wherein each one of said symbols is displayed under or over its respective associated word in the symbolated document.

8. The method of claim 1, wherein said user interface utilizes a standard web browser executing on the remote computing device.

9. The method of claim 8, wherein said user interface is executed without the use of a specialized plug in for said web browser.

10. The method of claim 1, wherein said user interface includes a spell check function that automatically suggests corrections to misspelled words.

11. The method of claim 1, wherein said user interface includes a function to automatically generate a table of contents for the symbolated document.

12. The method of claim 1, wherein said user interface includes a graphical editor for graphically editing any of the symbols.

13. A method of creating a symbolated document using a server comprising one or more computers and databases for executing specialized software for implementing said method which comprises the steps of:
the server sending instructions over a computer network to a remote computing device to cause a web browser executing on the remote computing device to provide a graphical user interface process including the steps of:
accepting textual words including nouns and verbs from a user for display in the document,
automatically suggesting one or more symbols, each comprising a graphical picture, for each one of said words, one at a time,
for each one of said subset of words, accepting a selection of one of said suggested one or more symbols for associating with that respective one of the words,
displaying the symbolated document on the remote computer device showing the textual words with the associated symbols provided above or below the respective associated textual words, and
sending document data representing the symbolated document displayed on the remote computing device to the server;
the server storing the document data; and
the server using the stored document data for interacting with one or more additional remote computing devices over the computer network for displaying the symbolated document on the additional remote computing devices, wherein
said browser does not require any installation of any specialized plugin from the server to provide said user interface.

14. The method of claim 13, wherein said user interface includes a step of automatically converting the textual words to speech, and wherein the displaying of the symbolated document on the additional remote computing devices includes providing the capability to convert the textual words to speech.

15. The method of claim 14, wherein said user interface includes accepting a user input for setting a speed of the speech.

16. The method of claim 13, wherein said user interface includes providing a user with one or more interactive puzzles for adding to the symbolated document.

17. The method of claim 13, wherein said user interface includes a global replace function for automatically replacing a plurality of a symbol that is associated with multiple instances of a particular word with another symbol for associating with that particular word.

18. The method of claim 13, wherein said user interface includes a spell check function that automatically suggests corrections to misspelled words.

19. The method of claim 13, wherein said user interface includes a function to automatically generate a table of contents for the symbolated document.

20. The method of claim 1, wherein said user interface includes a graphical editor for graphically editing any of the symbols.

21. A method of creating a symbolated document using a server comprising one or more computers and databases for executing specialized software for implementing said method which comprises the steps of:
the server sending instructions over a computer network to a remote computing device to cause the remote computing device to provide a graphical user interface process including the steps of:
accepting textual words including nouns and verbs from a user for display in the document,
automatically suggesting one or more symbols, each comprising a graphical picture, for each one of said words, one at a time,
for each one of said subset of words, accepting a selection of one of said suggested one or more symbols for associating with that respective one of the words,
providing a global replace function for automatically replacing a plurality of a symbol that is associated with multiple instances of a particular one of said words with another symbol for associating with that particular word,
providing a user with one or more interactive puzzles for adding to the symbolated document,
providing a graphical editor for providing a capability of graphically editing one or more of the symbols,
displaying the symbolated document on the remote computer device showing the textual words with the associated symbols provided above or below the respective associated textual words,
automatically converting the textual words to speech, such that the displaying of the symbolated document on the additional remote computing devices includes providing the capability to convert the textual words to speech, and
sending document data representing the symbolated document displayed on the remote computing device to the server;
the server storing the document data; and
the server using the stored document data for interacting with one or more additional remote computing devices over the computer network for displaying the symbolated document on the additional remote computing devices.

22. The method of claim 21, wherein said user interface utilizes a standard web browser executing on the remote computing device.

23. The method of claim 22, wherein said user interface is executed without the use of a specialized plug in for said web browser.
